(19) United States
(12) Patent Application Publication
(10) Pub. No.: US 2025/0014153 A1
(43) Pub. Date: Jan. 9, 2025

(54) DISTORTION COEFFICIENT CALIBRATION METHOD AND APPARATUS

(71) Applicant: Tencent Technology (Shenzhen) Company Limited, Shenzhen (CN)

(72) Inventors: Ziqi Li, Shenzhen (CN); Pan Ji, Shenzhen (CN); Hongdong Li, Shenzhen (CN)

(21) Appl. No.: 18/894,885

(22) Filed: Sep. 24, 2024

Related U.S. Application Data
(63) Continuation of application No. PCT/CN2023/130102, filed on Nov. 7, 2023.

(30) Foreign Application Priority Data
Dec. 13, 2022 (CN) 2022115939727

(51) Int. Cl. G06T 5/80; G06F 3/04847; G06T 7/80

(52) U.S. Cl. CPC G06T 5/80; G06F 3/04847; G06T 7/80

(57) ABSTRACT

A method and an apparatus for distortion coefficient calibration for an extended reality device is described. The method includes: obtaining a standard calibration image and a distortion calibration image, the distortion calibration image being formed by acquiring a screen through an optical lens of an extended reality device when a display of the extended reality device displays the standard calibration image as the screen; performing calibration point detection based on the standard calibration image and the distortion calibration image to obtain multiple calibration point pairs; obtaining a to-be-fitted distortion relationship comprising a to-be-determined distortion coefficient; and performing numerical fitting on the to-be-fitted distortion relationship according to the multiple calibration point pairs, to determine a value of the distortion coefficient in the to-be-fitted distortion relationship to obtain a distortion relationship configured for representing a conversion relationship between calibration points in the standard calibration image and the distortion calibration image.

### RELATED APPLICATIONS

This application is a continuation application of PCT Application PCT/CN2023/130102, filed Nov. 7, 2023, which claims priority to Chinese Patent Application No. 2022115939727 filed on Dec. 13, 2022, each entitled “DISTORTION COEFFICIENT CALIBRATION METHOD AND APPARATUS FOR EXTENDED REALITY DEVICE AND STORAGE MEDIUM”, and each which is incorporated herein by reference in its entirety.

### FIELD OF THE TECHNOLOGY

Aspects described herein generally relate to the field of computer and communication technologies, and specifically, to a distortion coefficient calibration method and apparatus for an extended reality device and a storage medium.

### BACKGROUND

With the rise of extended reality technologies, extended reality devices have emerged. Extended devices are also referred to as XR devices, and include virtual reality devices (also referred to as VR devices), augmented reality devices (AR devices), and mixed reality devices (MR devices). These devices can implement system simulation of three-dimensional dynamic scenes and entity behaviors.

When a user uses an extended reality device, light emitted by a display in the extended reality device enters human eyes through an optical lens. However, since the light may be distorted after passing through the optical lens in the extended reality device, an image viewed by the user through the extended reality device may be a distorted image. To enable the user to view a normal image, before the extended reality device may be used, distortion correction needs to be performed based on a distortion coefficient of the extended reality device. However, there may be currently no unified, standard, and automatic distortion coefficient calibration method.

### SUMMARY

According to aspects described herein, a distortion coefficient calibration method and apparatus for an extended reality device, a computer device, a storage medium, and/or a computer program product may be provided.

A distortion coefficient calibration method for an extended reality device may be provided, including:
obtaining a standard calibration image and a distortion calibration image, the distortion calibration image being formed by acquiring a screen through an optical lens of an extended reality device when a display of the extended reality device displays the standard calibration image as the screen;
performing calibration point detection based on the standard calibration image and the distortion calibration image to obtain multiple calibration point pairs, each of the calibration point pairs including a first calibration point belonging to the standard calibration image and a second calibration point belonging to the distortion calibration image, and the second calibration point being a corresponding calibration point obtained by acquiring the first calibration point through the optical lens of the extended reality device;
obtaining a to-be-fitted distortion relationship, the to-be-fitted distortion relationship including a to-be-determined distortion coefficient; and
performing numerical fitting on the to-be-fitted distortion relationship according to the multiple calibration point pairs, to determine a value of the distortion coefficient in the to-be-fitted distortion relationship to obtain a distortion relationship, the distortion relationship being configured for representing a conversion relationship between calibration points in the standard calibration image and the distortion calibration image.

A distortion coefficient calibration apparatus for an extended reality device may be provided, including:
an image obtaining module, configured to obtain a standard calibration image and a distortion calibration image, the distortion calibration image being formed by acquiring a screen through an optical lens of an extended reality device when a display of the extended reality device displays the standard calibration image as the screen;
a calibration point pair determining module, configured to perform calibration point detection based on the standard calibration image and the distortion calibration image to obtain multiple calibration point pairs, each of the calibration point pairs including a first calibration point belonging to the standard calibration image and a second calibration point belonging to the distortion calibration image, and the second calibration point being a corresponding calibration point obtained by acquiring the first calibration point through the optical lens of the extended reality device; and
a numerical fitting module, configured to obtain a to-be-fitted distortion relationship, the to-be-fitted distortion relationship including a to-be-determined distortion coefficient, and perform numerical fitting on the to-be-fitted distortion relationship according to the multiple calibration point pairs, to determine a value of the distortion coefficient in the to-be-fitted distortion relationship to obtain a distortion relationship, the distortion relationship being configured for representing a conversion relationship between calibration points in the standard calibration image and the distortion calibration image. A computer device may be provided, including a memory and a processor, the memory having a computer program stored therein, and the processor executing the computer program to implement the operations in any distortion coefficient calibration method for an extended reality device provided in the embodiments of this application.

A non-transitory computer-readable storage medium may be provided, having a computer program stored therein, the computer program being executed by a processor to implement the operations in any distortion coefficient calibration method for an extended reality device provided in the embodiments of this application.

A computer program product or a computer program may be provided, including computer instructions stored in a computer-readable storage medium. A processor of a computer device reads the computer instructions from the computer-readable storage medium, and the processor executes the computer instructions, so that the computer device executes the distortion coefficient calibration method for an extended reality device provided in the above optional embodiments.

Details of one or more aspects described herein are provided in the accompanying drawings and descriptions below. Other features and advantages of this application become apparent with reference to the specification, the accompanying drawings, and the claims.

### BRIEF DESCRIPTION OF THE DRAWINGS

To describe the technical solutions or the traditional technology more clearly, the following briefly describes the accompanying drawings required for describing the aspects. Apparently, the accompanying drawings in the following descriptions show merely illustrative aspects, and a person of ordinary skill in the art may still derive other accompanying drawings from the disclosed accompanying drawings without creative efforts.

FIG. 1 is a diagram of an application environment of a distortion coefficient calibration method for an extended reality device;

FIG. 2 is a schematic flowchart of a distortion coefficient calibration method for an extended reality device;

FIG. 3 is a schematic diagram of a calibration image;

FIG. 4 is a schematic diagram of acquiring a distortion calibration image;

FIG. 5 is a schematic diagram of a calibration point;

FIG. 6 is a schematic diagram in which a slide window moves towards any direction;

FIG. 7 is a schematic diagram in which an extended reality device displays an image;

FIG. 8 is a schematic diagram of an overall flow of distortion coefficient calibration;

FIG. 9 is a schematic flowchart of a distortion coefficient calibration method for an extended reality device;

FIG. 10 is a structural block diagram of a distortion coefficient calibration apparatus for an extended reality device;

FIG. 11 is a structural block diagram of a distortion coefficient calibration apparatus for an extended reality device;

FIG. 12 is a diagram of an internal structure of a computer device; and

FIG. 13 is a diagram of an internal structure of a computer device.

### DESCRIPTION OF EMBODIMENTS

The technical solutions will be described below clearly and comprehensively in conjunction with accompanying drawings of the embodiments of this application.

“Multiple” mentioned in the specification means two or more. “And/or” describes an association relationship between associated objects, and represents that there may be three relationships. For example, A and/or B may represent three cases: only A exists, both A and B exist, and only B exists. The character “/” generally indicates an “or” relationship between the associated objects.

An instruction sequence of a computer program may include various branch instructions, such as conditional jump instructions. The branch instruction may be an instruction in a computer program and allows a computer to execute different instruction sequences, thereby deviating from its default behavior of executing instructions in sequence.

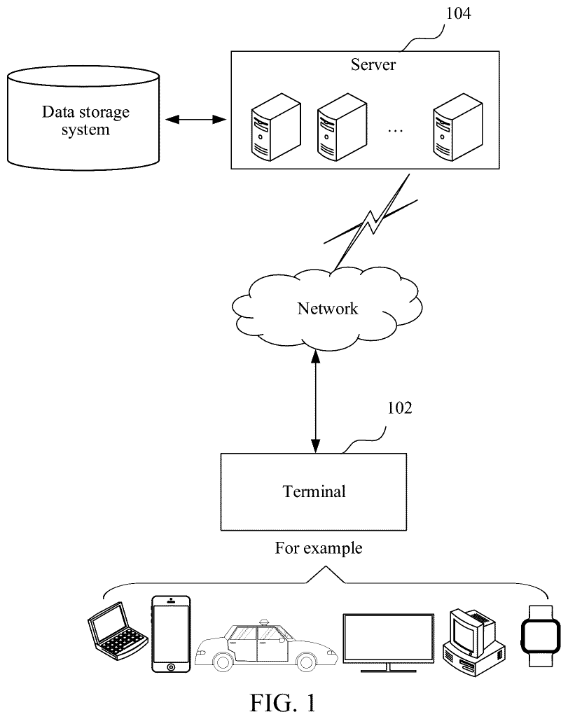

A distortion coefficient calibration method for an extended reality device may be applied to an application environment shown in FIG. 1. A terminal 102 may communicate with a server 104 by using a network. A data storage system may store data that needs to be processed by the server 104. The data storage system may be integrated on the server 104, or placed on the cloud or other servers. Both the terminal 102 and the server 104 may be separately configured to execute the distortion coefficient calibration method for an extended reality device. The terminal 102 and the server 104 may also be configured to execute the distortion coefficient calibration method for an extended reality device in coordination. An example through which the terminal 102 and the server 104 may be configured to execute the distortion coefficient calibration method for an extended reality device in coordination may be used. The terminal 102 may obtain a standard calibration image and a distortion calibration image, and send the standard calibration image and the distortion calibration image to the server 104, so that the server may determine a target value of a distortion coefficient of the extended reality device based on the standard calibration image and the distortion calibration image.

The terminal 102 may be but is not limited to various desktop computers, laptops, smartphones, tablets, IoT devices, and portable wearable devices. The IoT devices may include smart speakers, smart televisions, smart air conditioners, smart in-vehicle devices, or the like. The portable wearable devices may be extended reality devices, smart watches, smart bracelets, finger rings, handles, head-mounted devices, and the like. The server 104 may be implemented by using an independent server or a server cluster that includes multiple servers.

Aspects described herein relate to XR technologies. For example, aspects described herein relate to calibration of a distortion coefficient in an XR device. An XR technology, that is, an extended reality technology, refers to the integration of reality and virtuality through a computer technology and a wearable device to create a virtual environment for human-computer interaction, includes technical characteristics of VR, augmented reality (AR), and mediated reality (MR), and brings experiencers immersive feeling of seamless transition between the virtual world and the real world. The VR technology refers to the use of devices such as computers to generate a vivid virtual world with multiple sensory experiences such as three-dimensional vision, touch, and smell, so that people in the virtual world may have immersive feeling, and may be mostly used in game entertainment scenes, such as VR glasses, VR displays, and VR all-in-one machines. The AR technology may be a technology that superimposes virtual information onto the real world or even transcends reality. To some extent, it may be an extension of the VR technology. In comparison, AR device products have characteristics of small size, light weight, and portability. The MR technology may be further developments of VR and AR technologies, and may build a closed loop of communication between users by presenting virtual scenes in real scenes, greatly enhancing user experience. The XR technology may include the characteristics of the above three technologies and have bright application prospects, and may be used in remote teaching scenes of scientific and experimental courses in education and training, or immersive entertainment scenes in film and television entertainment, such as immersive movie viewing and games, or exhibition event scenes such as concerts, plays, and museums, or 3D home decoration and architectural design scenes in industrial modeling and design, or new consumption scenes, such as cloud shopping and cloud fitting.

The “first”, the “second”, and similar terms used in this application do not indicate any order, number or significance, but may be used to only distinguish different components. Unless the context clearly indicates otherwise, singular forms such as “one”, “a”, or “the” do not indicate a number limit, but rather indicate the existence of at least one. Numbers such as “multiple” or “multiple copies” mentioned in various aspects of this application all refer to the number of “at least two”. For example, “multiple” refers to “at least two”, and “multiple copies” refers to “at least two copies”.

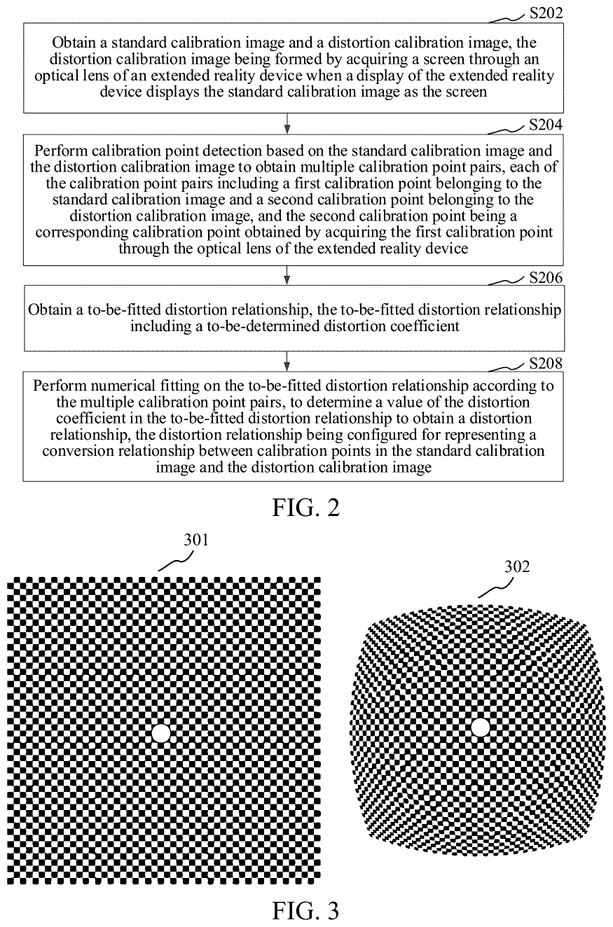

In an example, as shown in FIG. 2, a distortion coefficient calibration method for an extended reality device is provided, and application of this method to a computer device may be used as an example. The computer device may be the terminal or the server in FIG. 1. The distortion coefficient calibration method for an extended reality device includes the following operations:

Operation 202: Obtain a standard calibration image and a distortion calibration image, the distortion calibration image may be formed by acquiring a screen (e.g., screenshot) through an optical lens of an extended reality device when a display of the extended reality device displays the standard calibration image as the screen.

The standard calibration image refers to a standard image used for calibration. For example, since corner points of a chessboard grid image are evenly distributed and may include more distortion trends, the standard calibration image may be specifically a standard chessboard grid image, and the standard chessboard grid image may be a chessboard grid image with evenly distributed corner points. A corner point may be an extreme point. For example, a corner point when two straight lines form an angle may be referred to as a corner point. The distortion calibration image refers to an image after distortion of the standard calibration image. Distortion may refer to an abnormal change, for example, a morphological change. For example, referring to FIG. 3, FIG. 301 may be a standard calibration image, and FIG. 302 may be a distortion calibration image. FIG. 3 is a schematic diagram of a calibration image.

Specifically, when a distortion coefficient of an extended reality device needs to be determined, a computer device may obtain a standard calibration image and a distortion calibration image. Extended reality (XR) may be the collective name for various new immersive technologies such as virtual reality (VR), augmented reality (AR), and mediated reality (MR), and an extended reality device may be the collective name for a virtual reality device, an augmented reality device, and a mediated reality device. Theoretically, an extended reality technology may be a computer system that can create a virtual world or combine a real world with a virtual world. By creating a virtual world or combining a real world with a virtual world, users can experience highly immersive content. The distortion coefficient may be a coefficient used when an optical lens in an extended reality device produces distortion.

In an aspect, the distortion calibration image may be acquired by an image acquisition device; and in a process in which the image acquisition device acquires the distortion calibration image, the optical lens of the extended reality device may be located between the image acquisition device and the display of the extended reality device, and the optical center of the optical lens may be aligned with the center of the display.

Specifically, the distortion calibration image may be acquired by an image acquisition device. In a process of acquiring the distortion calibration image, the standard calibration image may be inputted to the extended reality device, and the standard calibration image may be displayed on an extended reality display, so that the image acquisition device may acquire the standard calibration image through the optical lens of the extended reality device, to obtain the distortion calibration image.

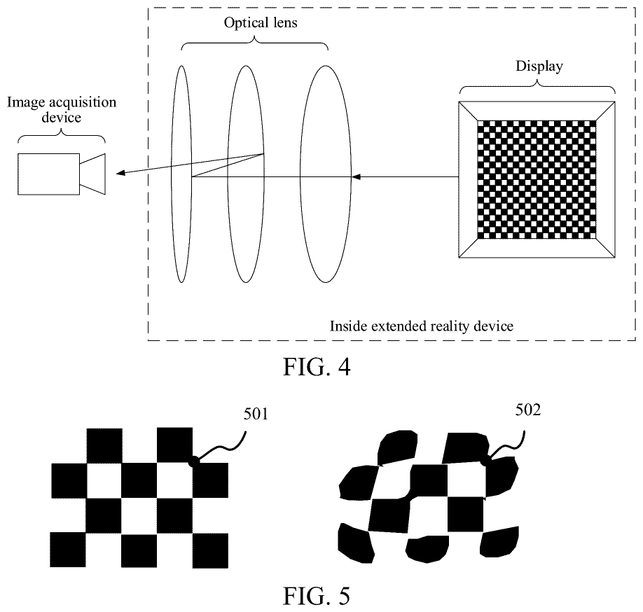

For example, referring to FIG. 4, the extended reality device may include an optical lens and a display. The optical lens may include multiple lenses. The optical center of the optical lens may be aligned with the center of the display first, so that light emitted by the display when displaying the standard calibration image may be transmitted to the image acquisition device through the optical lens, and then the image acquisition device may image the received light to obtain the distortion calibration image. FIG. 4 is a schematic diagram of acquiring a distortion calibration image.

In an aspect, the optical lens in the extended reality device may specifically be an XR optical lens with an ultra-short focal length and a complex folded optical path. This optical lens may be also referred to as an optical pancake lens. This optical lens may be an ultra-thin XR lens that folds an optical path through an optical element. By equipping the extended reality device with an optical pancake lens, the thickness of the extended reality device may be greatly reduced.

In an aspect, the pancake lens may be also referred to as a foldable light path lens, and adopt a “foldable” light path structure, which ensures the amplification of virtual images while shortening a straight-line distance from a screen to human eyes. The pancake lens may include a semi-reflective and semi-transparent lens, a phase retarder, and a reflective polarizer. In the pancake lens, after light emitted by the display in the XR device enters the semi-reflective and semi-transparent lens, the light may refract multiple times between the lens, the phase retarder, and the reflective polarizer, and may be finally emitted from the reflective polarizer. Through this solution, a volume of an optical part can be reduced, thereby reducing a volume of the entire XR device and improving wearing comfort.

In an aspect, for a distance between the image acquisition device and the optical lens, may refer to a distance between human eyes and the optical lens when a user uses the extended reality device. For example, the distance between the image acquisition device and the optical lens may be the same as the distance between human eyes and the optical lens.

In an aspect, the center of the image acquisition device, the optical center of the optical lens, and the center of the display may be aligned. For example, the center of the image acquisition device, the optical center of the optical lens, and the center of the display may be located on a horizontal line.

In the above aspect, only by displaying the standard calibration image on the display, the image acquisition device can conveniently and quickly acquire the distortion calibration image through the optical lens, thereby improving the acquisition efficiency of the distortion calibration image and improving the distortion coefficient calibration efficiency.

Operation 204: Perform calibration point detection based on the standard calibration image and the distortion calibration image to obtain multiple calibration point pairs, each of the calibration point pairs including a first calibration point belonging to the standard calibration image and a second calibration point belonging to the distortion calibration image, and the second calibration point being a corresponding calibration point obtained by acquiring the first calibration point through the optical lens of the extended reality device in a process of obtaining the distortion calibration image.

A calibration point may be a position point with a calibration characteristic in a calibration image. When the standard calibration image and the distortion calibration image are chessboard grid images, the calibration points may be corner points in the chessboard grid.

Specifically, when the standard calibration image and the distortion calibration image are obtained, the computer device may perform calibration point detection on the standard calibration image and the distortion calibration image, to obtain multiple first calibration points in the standard calibration image and second calibration points corresponding to the first calibration points in the distortion calibration image, thereby obtaining multiple calibration point pairs. For example, referring to FIG. 5, when a first calibration point 501 in the standard calibration image distorts to a second calibration point 502 in the distortion calibration image, the first calibration point 501 corresponds to the second calibration point 502. In this case, the first calibration point 501 and the second calibration point 502 may form a calibration point pair. Coordinates of the first calibration point in the standard calibration image may be referred to as first calibration point coordinates. Coordinates of the second calibration point in the distortion calibration image may be referred to as second calibration point coordinates. FIG. 5 is a schematic diagram of a calibration point.

In an aspect, when the calibration point may be a corner point, the computer device may perform calibration point detection on the standard calibration image and the distortion calibration image according to an opencv (a cross-platform computer vision and machine learning software library) corner point detection method, to obtain multiple calibration point pairs.

In an aspect, for each pixel block in the standard calibration image, the computer device may determine whether the pixel block includes a calibration point characteristic. If the pixel block includes a calibration point characteristic, the pixel block may be determined as the first calibration point. The computer device may determine whether the pixel block includes a calibration point characteristic through a pre-trained machine learning model. Correspondingly, the computer device may also determine the second calibration point through the above method. The pixel block may include one or more pixels.

In an aspect, a coordinate system may be established with the center of the standard calibration image as the origin, thereby determining coordinates of the first calibration point in the standard calibration image in the coordinate system, to obtain the first calibration point coordinates. Correspondingly, a coordinate system may be established with the center of the distortion calibration image as the origin, thereby determining coordinates of the second calibration point in the distortion calibration image in the coordinate system, to obtain the second calibration point coordinates.

In an aspect, before performing calibration point detection on the standard calibration image and the distortion calibration image, sizes of the standard calibration image and the distortion calibration image may be adjusted so that the sizes of the standard calibration image and the distortion calibration image are unified.

Operation 206: Obtain a to-be-fitted distortion relationship, the to-be-fitted distortion relationship including a to-be-determined distortion coefficient.

Specifically, the computer device may obtain a preset to-be-fitted distortion relationship, the to-be-fitted distortion relationship may be configured for obtaining a distortion relationship through fitting, and the distortion relationship may be configured for representing a conversion relationship between calibration points in the standard calibration image and the distortion calibration image. The distortion coefficient in the to-be-fitted distortion relationship may be to be determined.

In an aspect, taking the classic Brown model as an example, the to-be-fitted distortion relationship may be determined by the following formula:

$$\{ \begin{matrix}{r}_{d} = f ( {r}_{u} ) = {r}_{u} + {c}_{1} {r}_{u}^{3} + {c}_{2} {r}_{u}^{5} \\ {r}_{u}^{2} = {x}_{u}^{2} + {y}_{u}^{2} \\ {r}_{d}^{2} = {x}_{d}^{2} + {y}_{d}^{2}\end{matrix}$$

rᵤ indicates an undistorted distance; and r_{d} indicates a distorted distance. The undistorted distance may be a distance between the first calibration point coordinates and the center point of the standard calibration image. The distorted distance may be a distance between the second calibration point coordinates and the center point of the distortion calibration image. (xᵤ, yᵤ) indicates the first calibration point coordinates. The first calibration point coordinates may be coordinates determined by establishing a coordinate system with the center point of the standard calibration image as the origin. (x_{d}, y_{d}) indicates the second calibration point coordinates. The second calibration point coordinates may be coordinates determined by establishing a coordinate system with the center point of the distortion calibration image as the origin. c₁ and c₂ are to-be-determined distortion coefficients. The first calibration point coordinates may be coordinates of the first calibration point in the standard calibration image. The second calibration point coordinates may be coordinates of the second calibration point in the distortion calibration image.

Operation 208: Perform numerical fitting on the to-be-fitted distortion relationship according to the multiple calibration point pairs, to determine a value of the distortion coefficient in the to-be-fitted distortion relationship to obtain a distortion relationship, the distortion relationship being configured for representing a conversion relationship between calibration points in the standard calibration image and the distortion calibration image.

Numerical fitting may be also referred to as curve fitting, commonly known as curve forming, and refers to a process of obtaining a continuous function (that is, a curve) based on several pieces of discrete data. The obtained continuous function may be consistent with the inputted several pieces of discrete data. Based on the conversion relationship between the calibration points in the standard calibration image and the distortion calibration image, the calibration points in the standard calibration image may be converted into calibration points in the distortion calibration image. For example, the distortion relationship may be specifically a function. After coordinates of a calibration point A in the distortion calibration image are inputted to the function, the function may output coordinates of a calibration point B in the standard calibration image corresponding to the calibration point A.

Specifically, when multiple calibration point pairs are obtained, the computer device may determine coordinate pairs respectively corresponding to the calibration point pairs. The coordinate pair includes coordinates of the first calibration point and coordinates of the second calibration point, and the first calibration point and the second calibration point belong to the same calibration point pair. For example, when the calibration point pair A includes a first calibration point a and a second calibration point b, a coordinate pair A corresponding to the calibration point pair A may include coordinates of the first calibration point a and coordinates of the second calibration point b. According to the coordinate pairs corresponding to the multiple calibration point pairs, the value of the to-be-determined distortion coefficient in the to-be-fitted distortion relationship may be determined. For example, values of c₁ and c₂ in the above formula may be determined. The target value of the distortion coefficient may be a distortion coefficient value used when the optical lens of the extended reality device produces distortion. At this point, the distortion coefficient used when the extended reality device produces distortion has been calibrated. By calibrating the distortion coefficient, subsequent distortion correction, depth estimation, spatial positioning, and the like may be performed based on the calibrated distortion coefficient.

In an aspect, the computer device may perform numerical fitting on the to-be-fitted distortion relationship through a least squares method, a gradient descent learning method, a trust region algorithm, a Gauss-Newton iteration method, or the like based on multiple calibration point pairs, to obtain the value of the distortion coefficient in the to-be-fitted distortion relationship.

In the above distortion coefficient calibration method for an extended reality device, by obtaining the standard calibration image and the distortion calibration image after distortion of the standard calibration image, calibration point detection may be performed on the standard calibration image and the distortion calibration image, thereby obtaining a calibration point pair including the first calibration point before distortion and the second calibration point after distortion. In this way, based on multiple calibration point pairs, numerical fitting may be performed on the to-be-fitted distortion relationship to obtain the value of the distortion coefficient of the to-be-fitted distortion relationship, that is, obtain the distortion relationship that represents the conversion relationship between the calibration points in the standard calibration image and the distortion calibration image, thereby achieving the purpose of automatic calibration of the distortion coefficient. Since the method described herein only requires one standard calibration image to achieve distortion coefficient calibration of the extended reality device, the process of distortion coefficient calibration may be greatly simplified and the distortion coefficient calibration efficiency may be improved.

In an aspect, the performing calibration point detection based on the standard calibration image and the distortion calibration image to obtain multiple calibration point pairs includes: performing calibration point detection on the standard calibration image to obtain multiple first calibration points, and determining coordinates of each of the first calibration points in the standard calibration image, to obtain first calibration point coordinates respectively corresponding to the multiple first calibration points; performing calibration point detection on the distortion calibration image to obtain multiple second calibration points, and determining coordinates of each of the second calibration points in the distortion calibration image, to obtain second calibration point coordinates respectively corresponding to the multiple second calibration points; determining a positional relationship between the first calibration points according to the first calibration point coordinates respectively corresponding to the multiple first calibration points; determining a positional relationship between the second calibration points according to the second calibration point coordinates respectively corresponding to the multiple second calibration points; and performing matching between the multiple first calibration points and the multiple second calibration points according to the positional relationship between the first calibration points and the positional relationship between the second calibration points, to obtain the multiple calibration point pairs.

Specifically, the computer device may perform calibration point detection on the standard calibration image to identify each first calibration point in the standard calibration image, and output first calibration point coordinates corresponding to each first calibration point. The first calibration point may refer to a pixel or a pixel block in the standard calibration image, and correspondingly, the first calibration point coordinates may refer to position coordinates of the pixel or the pixel block in the standard calibration image. For example, referring to FIG. 5, when the standard calibration image is a chessboard grid image, the white in the standard calibration image may be used as the background color. Then, the computer device may identify a corner point of each black grid and use the identified corner point as the first calibration point. Correspondingly, the computer device may also perform calibration point detection on the distortion calibration image, use the white in the distortion calibration image as the background color, identify a corner point of a black grid in the distortion calibration image, obtain multiple second calibration points, and output second calibration point coordinates respectively corresponding to the second calibration points.

Further, the computer device determines the positional relationship between the first calibration points according to abscissa and ordinate values of the first calibration point coordinates. Since there may be a one-to-one correspondence between the first calibration point and the first calibration point coordinates, the positional relationship between the first calibration points may be also the positional relationship between the first calibration point coordinates. For example, when first calibration point coordinates of a first calibration point A are (1, 1), first calibration point coordinates of a first calibration point B are (1, 0), and first calibration point coordinates of a first calibration point C are (0, 1), it may be considered that the first calibration point A may be located on the right of the first calibration point C and above the first calibration point B. Further, the computer device sorts the first calibration points according to the positional relationship between the first calibration points to obtain a first calibration point matrix. For example, in the first calibration point matrix, the mark A of the first calibration point A may be located on the right of the mark C of the first calibration point C and above the mark B of the first calibration point B. Correspondingly, the computer device may determine the positional relationship between the second calibration points in the above manner. Since there may be a one-to-one correspondence between the second calibration point and the second calibration point coordinates, the positional relationship between the second calibration points may be the positional relationship between the second calibration point coordinates, and the second calibration points are sorted according to the positional relationship between the second calibration points to obtain a second calibration point matrix.

Further, the computer device uses the first calibration point and the second calibration point located at the same position in the first calibration point matrix and the second calibration point matrix as a calibration point pair, and uses first calibration point coordinates of the first calibration point and second calibration point coordinates of the second calibration point in a calibration point pair as a coordinate pair. For example, when it is determined that the first calibration point A is located at the intersection of the first row and the first column in the first calibration point matrix, and the second calibration point D is located at the intersection of the first row and the first column in the second calibration point matrix, it may be determined that first calibration point coordinates corresponding to the first calibration point A and second calibration point coordinates corresponding to the second calibration point D are a coordinate pair of the calibration points.

In this aspect, by performing calibration point detection, a calibration point pair that reflects the change before and after calibration point distortion may be obtained, so that the distortion coefficient of the extended reality device may be subsequently obtained based on the calibration point pair. In addition, since the positional relationship between the points in the image does not change after the image may be distorted, by determining the positional relationship between the first coordinate points and determining the positional relationship between the second coordinate points, calibration points that correspond to each other before and after distortion may be accurately obtained based on the determined positional relationship.

In an aspect, the performing calibration point detection on the standard calibration image to obtain multiple first calibration points may include: obtaining a slide window and triggering the slide window to slide on the standard calibration image according to a preset moving step size, to obtain a standard partial image selected by the slide window; determining a first overall grayscale value of the standard partial image; triggering the slide window to move towards any direction multiple times to obtain multiple standard partial images after movement corresponding to the current standard partial image; determining a second overall grayscale value of each of the standard partial images after movement; and extracting the first calibration point from the standard partial image according to that a difference between each second overall grayscale value and the first overall grayscale value may be greater than or equal to a preset difference threshold.

Specifically, when the first calibration point needs to be identified, the computer device may generate a slide window and trigger the slide window to slide on the standard calibration image according to a preset moving step size. For example, the computer device may trigger the slide window to slide on the slide window from top to bottom from left to right. The image selected by the slide window may be referred to as a standard partial image. For each standard partial image selected by the slide window, the computer device may determine whether the standard partial image selected by the slide window includes a calibration point characteristic, and if yes, determine that there may be a calibration point in the slide window and use the calibration point as the first calibration point.

In an aspect, when the calibration point may be a corner point, the corner point may be a corner point of an edge, and the characteristic of the edge may be that a gradient suddenly changes in a direction. Therefore, the corner point may indicate that an area has gradient information of edge changes in two or multiple directions. If a slide window may be used to observe a corner point area, as the slide window slides in multiple directions, a strong change (a gradient) of pixel density may be perceived, that is, the overall grayscale value change may be perceived.

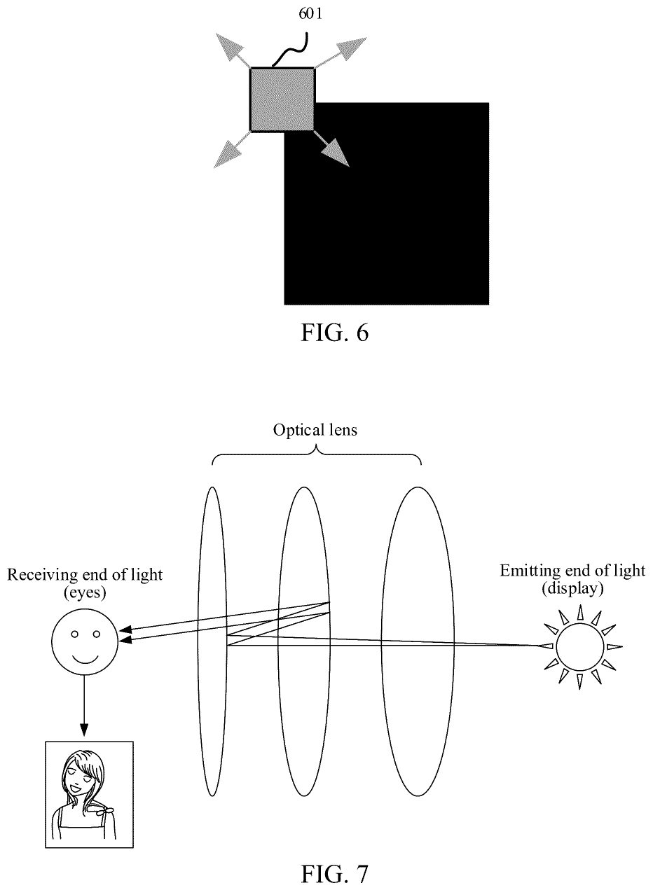

Based on the above principle, the standard partial image currently selected by the slide window may be referred to as the current standard partial image. When the current standard partial image may be selected by the slide window, referring to FIG. 6, the computer device may trigger the slide window 601 to move multiple times in any direction, to obtain multiple moved slide windows, and contents selected by the moved slide windows are referred to as standard partial images after movement. The computer device may determine an overall grayscale value of the current standard partial image, where the overall grayscale value of the current standard partial image may be referred to as a first overall grayscale value, determine an overall grayscale value of each standard partial image after sliding, where the overall grayscale value may be referred to as a second overall grayscale value, determine a difference between the second overall grayscale value of each standard partial image after sliding and the first overall grayscale value of the current standard partial image, and when each difference is greater than or equal to a preset difference threshold, may determine that the current standard partial image includes a corner point characteristic. In this case, a point pointed by the corner point characteristic may be used as the first calibration point. For example, if the center point of the current standard partial image may be a corner point, the center point of the current standard partial image may be used as the first calibration point. FIG. 6 may be a schematic diagram in which a slide window moves towards any direction according to an aspect.

In an aspect, the computer device may determine grayscale values of pixels in the current standard partial image, and use an average of the grayscale values of the pixels in the current standard partial image as the first overall grayscale value. Correspondingly, the computer device may determine grayscale values of pixels in the standard partial image after movement, and use an average of the grayscale values of the pixels in the standard partial image after movement as the second overall grayscale value.

In the above aspect, the slide window may be triggered to slide in the standard calibration image according to the moving step size, so that the standard calibration image may be divided into multiple standard partial images. Therefore, the first calibration point in the standard calibration image may be accurately identified based on the multiple standard partial images obtained by the division. When the current standard partial image is selected, by triggering the slide window to slide in any direction, the current standard partial image after sliding may be obtained. In this way, based on the overall grayscale value of the current standard partial image before sliding and the overall grayscale value of the current standard partial image after sliding, it can be quickly and accurately determined whether the current standard partial image includes a corner point characteristic, and then the corresponding first calibration point may be determined based on the corner point characteristic.

In an aspect, the extracting the first calibration point from the standard partial image according to a difference between each second overall grayscale value and the first overall grayscale value includes: performing subtraction on each second overall grayscale value and the first overall grayscale value to obtain a grayscale difference corresponding to each second overall grayscale value; obtaining absolute values of grayscale differences, and selecting absolute values greater than or equal to a preset difference threshold from the absolute values of the grayscale differences; determining a number of the selected absolute values, and when the number may be greater than or equal to a preset number threshold, using the center of the standard partial image as the first calibration point.

Specifically, when obtaining the second overall grayscale value of each standard partial image after movement, the computer device may perform subtraction on each second overall grayscale value and the first overall grayscale value, to obtain a grayscale value difference corresponding to each second overall grayscale value. For example, the computer device subtracts the first overall grayscale value from a second overall grayscale value A to obtain a grayscale difference corresponding to the second overall grayscale value A, and subtracts the first overall grayscale value from a second overall grayscale value B to obtain a grayscale difference corresponding to the second overall grayscale value B. Further, the computer device obtains the absolute values of the grayscale differences to obtain multiple absolute values, determines target absolute values greater than or equal to the preset difference threshold, and counts a number of the selected target absolute values. When the number of the selected target absolute values is greater than or equal to a preset number threshold, the center of the current standard partial image may be used as the first calibration point. For example, when a difference between each second overall grayscale value and the first overall grayscale value may be greater than or equal to a preset difference threshold, the center of the current standard partial image may be used as the first calibration point.

In the above aspect, the second overall grayscale value may be the overall grayscale value of the standard partial image after movement, and the standard partial image after movement may be obtained by moving the standard partial image. Therefore, when the difference between each second overall grayscale value and the first overall grayscale value may be greater than or equal to the preset difference threshold, it may be considered that there may be such a target area in the standard partial image that overall grayscale values of other areas around the target area may be smaller than the overall grayscale value of the target area. It may be known that the grayscale value of the corner point area may be greater than a grayscale value of an area around the corner point. Therefore, when it may be determined that there may be such a target area in the standard partial image that overall grayscale values of other areas around the target area may be smaller than the overall grayscale value of the target area, it may be considered that the target area may be an area in which a corner point may be located. Therefore, the target area may be used as the first calibration point. In this way, the determination of the first calibration point may be achieved.

In an aspect, the performing calibration point detection on the distortion calibration image to obtain multiple second calibration points may include: obtaining a slide window and triggering the slide window to slide on the distortion calibration image according to a preset moving step size, to obtain a distortion partial image selected by the slide window; determining a third overall grayscale value of the distortion partial image; triggering the slide window to move towards any direction multiple times to obtain multiple distortion partial images after movement corresponding to the distortion partial image; determining a fourth overall grayscale value of each of the distortion partial image after movement; and extracting the second calibration point from the distortion partial image according to a difference between each fourth overall grayscale value and the third overall grayscale value.

Specifically, when the second calibration point needs to be identified, the computer device may generate a slide window and trigger the slide window to slide on the distortion calibration image according to a preset moving step size. For example, the computer device may trigger the slide window to slide on the slide window from top to bottom from left to right. For each distortion partial image selected by the slide window, the computer device may determine whether the distortion partial image includes a calibration point characteristic, and if yes, determine that there may be a calibration point in the slide window and use the calibration point as the second calibration point. For determining of whether the distortion partial image selected by the slide window includes a calibration point characteristic, refer to the above aspect. In this aspect, details are not described herein again. In an aspect, a size of the slide window generated for the distortion calibration image may be consistent with a size of the slide window generated for the standard calibration image. A moving step size of the slide window for the distortion calibration image may be consistent with a moving step size of the slide window for the standard calibration image.

In an aspect, the computer device may also identify only some calibration points in the standard calibration image and the distortion calibration image, without identifying all calibration points. For example, only calibration points near center areas in the standard calibration image and the distortion calibration image may be identified.

In the above aspect, the slide window may be triggered to slide in the distortion calibration image according to the moving step size, so that the distortion calibration image may be divided into multiple distortion partial images. Therefore, the second calibration point in the distortion calibration image may be accurately identified based on the multiple distortion partial images obtained by the division.

In an aspect, the performing numerical fitting on the to-be-fitted distortion relationship according to the multiple calibration point pairs, to determine a target value of the distortion coefficient in the to-be-fitted distortion relationship includes: obtaining a preset distortion coefficient value increment model; where the distortion coefficient value increment model may be generated based on the distortion coefficient in the initial distortion relationship; determining a predicted value of the distortion coefficient of a current round; obtaining a predicted value increment of the distortion coefficient of the current round through the distortion coefficient value increment model according to the multiple calibration point pairs and the predicted value of the distortion coefficient of the current round; when the predicted value increment of the distortion coefficient does not meet the numerical convergence condition, adding the predicted value increment of the distortion coefficient of the current round and the predicted value of the distortion coefficient of the current round, to obtain an updated predicted value of the distortion coefficient; using a next round as the current round, using the updated predicted value as a predicted value of the distortion coefficient of the current round, and returning to continue to perform the operation of obtaining a predicted value increment of the distortion coefficient of the current round through the distortion coefficient value increment model according to the multiple calibration point pairs and the predicted value of the distortion coefficient of the current round, until the predicted value increment of the distortion coefficient meets the numerical convergence condition; and using a predicted value of the distortion coefficient of the last round as the value of the distortion coefficient in the to-be-fitted distortion relationship.

Specifically, the computer device may obtain a preset distortion coefficient value increment model, where the distortion coefficient value increment model may be configured for determining a change amount of the predicted value of the distortion coefficient in two consecutive iterations. The distortion coefficient increment model may specifically be a function, or may be a change amount function model for predicting the predicted value of the distortion coefficient in two consecutive iterations. The computer device may determine the predicted value of the distortion coefficient of the current round, inputs the predicted value of the distortion coefficient of the current round and multiple calibration point pairs into the distortion coefficient value increment model, and outputs the predicted value increment of the distortion coefficient of the current round through the distortion coefficient value increment model. The computer device may determine whether the predicted value increment of the distortion coefficient of the current round meets a preset numerical convergence condition. If the preset numerical convergence condition is not met, the computer device may add the predicted value increment of the distortion coefficient and the predicted value of the distortion coefficient of the current round, to obtain an updated predicted value of the distortion coefficient. Then, a next round of iteration may be entered, the obtained updated predicted value of the distortion coefficient may be used as the predicted value of the distortion coefficient of the current round, and the distortion coefficient value incremental model may continue to be triggered to output the predicted value increment of the distortion coefficient of the current round based on multiple calibration point pairs and the predicted value of the distortion coefficient of the current round, until the outputted predicted value increment of the distortion coefficient of the current round meets the numerical convergence condition.

When the predicted value of the distortion coefficient of the current round meets the numerical convergence condition, the computer device may use the predicted value of the distortion coefficient of the current round as the value of the distortion coefficient in the distortion relationship. The value of the distortion coefficient may be a value of the distortion coefficient used when the extended reality device produces distortion.

In an aspect, the computer device may obtain a preset convergence value. For example, the convergence value may be 1e⁻⁸, and the predicted value increment of the distortion coefficient of the current round may be compared with the convergence value. If the predicted value increment of the distortion coefficient of the current round is less than or equal to the convergence value, it may be determined that the predicted value increment of the distortion coefficient of the current round meets the numerical convergence condition; otherwise, it may be determined that the numerical convergence condition is not met.

In an aspect, the preset value may be used as the predicted value of the distortion coefficient of the first round.

In an aspect, the distortion coefficient value increment model may be determined based on a residual model; the residual model may be determined based on the to-be-fitted distortion relationship; the residual model may represent residual between a first coordinate change and a second coordinate change; the first coordinate change may be a change between a coordinate before distortion and a coordinate after distortion determined based on the predicted value of the distortion coefficient; and the second coordinate change may be a change between a coordinate before distortion and a coordinate after distortion determined based on an actual value of the distortion coefficient.

Specifically, the corresponding residual model may be determined first based on the to-be-fitted distortion relationship. The residual model may be configured for representing residual between the change between the coordinate before distortion and the coordinate after distortion determined based on the predicted value of the distortion coefficient and the change between the coordinate before distortion and the coordinate after distortion determined based on the actual value of the distortion coefficient. Then, the difference between the predicted value and the actual value of the distortion coefficient in the distortion relationship may be determined based on the residual between the change between the coordinate before distortion and the coordinate after distortion determined based on the predicted value of the distortion coefficient and the change between the coordinate before distortion and the coordinate after distortion determined based on the actual value of the distortion coefficient. The predicted value of the distortion coefficient may be a fitted value obtained through numerical fitting. The actual value of the distortion coefficient may be a target of numerical fitting.

Further, to achieve a minimum value of least squares optimization for the residual model, Taylor expansion may be performed on the residual model to obtain the distortion coefficient value increment model. In an aspect, to achieve a minimum value of least squares optimization for the residual model, a partial derivative of the residual model in the direction of the distortion coefficient may be determined first to obtain the Jacobian matrix model. Then, through Taylor expansion, a Gauss-Newton condition, and a first-order derivative being zero, the distortion coefficient value increment model may be obtained.

In an aspect, the distortion coefficient value increment model may be determined by the following formula:

$$[ \begin{matrix}Δ {c}_{1} \\ Δ {c}_{2}\end{matrix} ] = {( {J ( {c}_{1} , {c}_{2} )}^{T} J ( {c}_{1} , {c}_{2} ) )}^{- 1} ( - {J ( {c}_{1} , {c}_{2} )}^{T} r ( {c}_{1} , {c}_{2} ) ) \\ J ( {c}_{1} , {c}_{2} ) = [ \begin{matrix}\frac{\partial F ( {c}_{1} , {c}_{2} )}{\partial {c}_{1}} & \frac{\partial F ( {c}_{1} , {c}_{2} )}{\partial {c}_{2}} \\ \frac{\partial G ( {c}_{1} , {c}_{2} )}{\partial {c}_{1}} & \frac{\partial G ( {c}_{1} , {c}_{2} )}{\partial {c}_{2}}\end{matrix} ] \\ F ( {c}_{1} , {c}_{2} ) = {\sum }_{i = 1}^{N} [ {x}_{di} ( 1 + {c}_{1} {r}_{di}^{3} + {c}_{2} {r}_{di}^{5} ) - {x}_{ui} ] \\ G ( {c}_{1} , {c}_{2} ) = {\sum }_{i = 1}^{N} [ {y}_{di} ( 1 + {c}_{1} {r}_{di}^{3} + {c}_{2} {r}_{di}^{5} ) - {y}_{ui} ]$$

where

$$[ \begin{matrix}Δ {c}_{1} \\ Δ {c}_{2}\end{matrix} ]$$

may be a value increment model; Δc₁ and Δc₂ may be both predicted value increments of the distortion coefficient; F(c₁, c₂) and G(c₁, c₂) may be both residual models; (xᵤᵢ, yᵤᵢ) may be first calibration point coordinates in an i^{th} coordinate pair; (x_{di}, y_{di}) may be second calibration point coordinates in the i^{th} coordinate pair; rᵤᵢ may be an undistorted distance determined based on (xᵤᵢ, yᵤᵢ); Tai may be a distorted distance determined based on (x_{di}, y_{di}); and c₁ and c₂ are to-be-determined distortion coefficients. The model may be a calculation formula, and the matrix may be a specific value outputted based on the calculation formula. For example, the residual matrix may be a matrix calculation formula related to the variables c₁ and c₂. A calculation result of this calculation formula may be referred to as the residual matrix. The i^{th} coordinate pair corresponds to an i^{th} calibration point pair.

In the above aspect, when the predicted value increment of the distortion coefficient converges to close to zero, it may mean that even if the iteration continues, the fitted predicted value of the distortion coefficient may be almost unchanged. At the same time, the coordinate residual of each iteration in this system may be generated by the distortion coefficient of the iteration. Therefore, in this system, the residual model may be used as a relational expression (F and G) to optimize a partial derivative in the direction of the distortion coefficient (c1 and c2). When the iterative residual of the distortion coefficient converges to a small range, it means that the residual model may have reached an optimized target minimum value, that is, means that the distortion coefficient value corresponding to the distortion relationship has been obtained through fitting.

In an aspect, obtaining a predicted value increment of the distortion coefficient of the current round through the distortion coefficient value increment model according to the multiple calibration point pairs and the predicted value of the distortion coefficient of the current round may include: obtaining a Hessian matrix of the current round through a Hessian matrix model in the distortion coefficient value increment model according to the multiple calibration point pairs; obtaining an iteration matrix of the current round through an iteration matrix model in the distortion coefficient value increment model according to the multiple calibration point pairs and the predicted value of the distortion coefficient of the current round; and fusing the Hessian matrix of the current round and the iteration matrix of the current round to obtain the predicted value increment of the distortion coefficient of the current round.

Specifically, the distortion coefficient value increment model includes a Hessian matrix model and an iteration matrix model. The Hessian matrix model may be a model for outputting a Hessian matrix. For example, the Hessian matrix model may be a function model. The iteration matrix model may be a model for outputting an iteration matrix. For example, the iteration matrix model may be a function model. In the current round, the computer device may obtain the Hessian matrix of the current round based on the multiple calibration point pairs and the Hessian matrix, and output the iteration matrix of the current round based on the multiple calibration point pairs, the predicted value of the distortion coefficient of the current round, and the iteration matrix model. The computer device may fuse the iteration matrix of the current round and the Hessian matrix, for example, multiplies the negative first power of the Hessian matrix with the iteration matrix to obtain the predicted value increment of the distortion coefficient of the current round.

In an aspect, the Hessian matrix describes a local curvature of a function. When the distortion coefficient value increment model is

$$[ \begin{matrix}Δ {c}_{1} \\ Δ {c}_{2}\end{matrix} ] = {( {J ( {c}_{1} , {c}_{2} )}^{T} J ( {c}_{1} , {c}_{2} ) )}^{- 1} ( - {J ( {c}_{1} , {c}_{2} )}^{T} r ( {c}_{1} , {c}_{2} ) ) , ( {J ( {c}_{1} , {c}_{2} )}^{T} J ( {c}_{1} , {c}_{2} ) )$$

may be the Hessian matrix model, and (−J(c₁,c₂)^{T}r(c₁,c₂)) may be the iteration matrix model. Therefore, coordinate pairs corresponding to the multiple calibration point pairs may be inputted into (J(c₁,c₂)^{T}J(c₁,c₂)) to obtain a specific Hessian matrix, the coordinate pairs corresponding to the multiple calibration point pairs and the predicted value of the distortion coefficient of the current round may be inputted into the formula (−J(c₁,c₂)^{T}r(c₁,c₂)) to obtain a specific iteration matrix, and the negative first power of the Hessian matrix may be multiplied with the iteration matrix to obtain the predicted value increment of the distortion coefficient in the current round.

In the above aspect, by determining the Hessian matrix and the iteration matrix, a change amount between predicted values of the distortion coefficient in two consecutive iterations may be predicted based on the Hessian matrix and the iteration matrix, so that the value of the distortion coefficient may be subsequently determined based on the change amount between the predicted values of the distortion coefficient in two consecutive iterations.

In an aspect, obtaining a Hessian matrix of the current round through a Hessian matrix model in the distortion coefficient value increment model according to the multiple calibration point pairs may include: for each of the multiple calibration point pairs, obtaining, through a Jacobian matrix model in a Hessian matrix model based on a coordinate pair corresponding to the target calibration point pair, a current Jacobian matrix corresponding to the current calibration point pair; fusing the current Jacobian matrix and the transpose of the current Jacobian matrix to obtain a fused Jacobian matrix corresponding to the target calibration point pair; and superimposing fused Jacobian matrices respectively corresponding to the multiple calibration point pairs, to obtain the Hessian matrix of the current round.

Specifically, the Hessian matrix model may include the Jacobian matrix model. When the Hessian matrix of the current round needs to be determined, the computer device may input the coordinate pair corresponding to each calibration point pair into the Jacobian matrix model in the Hessian matrix model, to obtain a Jacobian matrix corresponding to each calibration point pair. Further, for each of the multiple calibration point pairs, the computer device may determine the transpose of the Jacobian matrix corresponding to the target calibration point pair to obtain the transpose of the Jacobian matrix, and fuse the Jacobian matrix and the transpose of the Jacobian matrix corresponding to the same calibration point pair, to obtain the fused Jacobian matrix corresponding to each calibration point pair. For example, the Jacobian matrix corresponding to the calibration point pair A may be multiplied with the transpose of the Jacobian matrix to obtain the fused Jacobian matrix corresponding to the calibration point pair A. When fused Jacobian matrices corresponding to the calibration point pairs are obtained, the computer device may superimpose the fused Jacobian matrices to obtain the Hessian matrix of the current round.

In an aspect, the computer device may set an initial value of the Hessian matrix and traverse calibration point pairs. For the first traversed calibration point pair, the computer device may determine a Jacobian matrix of the first traversed calibration point pair, and multiply the Jacobian matrix with the transpose of the Jacobian matrix to obtain a fused Jacobian matrix of the first traversed calibration point pair. The computer device superimposes the initial value of the Hessian matrix and the fused Jacobian matrix to obtain a superimposed Hessian matrix of the first traversed calibration point pair. The computer device continues to determine a fused Jacobian matrix of a next traversed calibration point pair, and superimposes the fused Jacobian matrix of the next traversed calibration point pair and the superimposed Hessian matrix of the first traversed calibration point pair, to obtain a superimposed Hessian matrix of the next traversed calibration point pair. Iteration may be performed in this way until the last calibration point pair may be traversed, and a superimposed Hessian matrix of the last traversed calibration point pair may be used as the Hessian matrix of the current round.

In an aspect, in the process of calculating the Jacobian matrix corresponding to the i^{th} calibration point pair, assuming that the coordinate pair corresponding to the i^{th} calibration point pair is [(xᵤᵢ, yᵤᵢ), (x_{di}, y_{di})], the computer may determine an undistorted distance rᵤᵢ corresponding to the first calibration point coordinates (xᵤᵢ, yᵤᵢ), determines a distorted distance r_{di} corresponding to the second calibration point coordinates (x_{di}, y_{di}), and inputs (xᵤᵢ, yᵤᵢ), rᵤᵢ, (x_{di}, y_{di}), and r_{di} to the Jacobian matrix model

$$J ( {c}_{1} , {c}_{2} ) = [ \begin{matrix}\frac{\partial F ( {c}_{1} , {c}_{2} )}{\partial {c}_{1}} & \frac{\partial F ( {c}_{1} , {c}_{2} )}{\partial {c}_{2}} \\ \frac{\partial G ( {c}_{1} , {c}_{2} )}{\partial {c}_{1}} & \frac{\partial G ( {c}_{1} , {c}_{2} )}{\partial {c}_{2}}\end{matrix} ] ,$$

to obtain the Jacobian matrix

$$[ \begin{matrix}{x}_{di} * {r}_{di}^{3} & {x}_{di} * {r}_{di}^{5} \\ {y}_{di} * {r}_{di}^{3} & {y}_{di} * {r}_{di}^{5}\end{matrix} ]$$

of the i^{th} coordinate pair [(xᵤᵢ, yᵤᵢ), (x_{di}, y_{di})]. The Jacobian matrix corresponding to the i^{th} coordinate pair may be also the Jacobian matrix corresponding to the i^{th} calibration point pair.

In the above aspect, by determining the fused Jacobian matrices of all the calibration point pairs, the Hessian matrix of the current round can be quickly obtained based on the fused Jacobian matrices of all the calibration point pairs.

In an aspect, the obtaining an iteration matrix of the current round through an iteration matrix model in the distortion coefficient value increment model according to the multiple calibration point pairs and the predicted value of the distortion coefficient of the current round may include: for each of the multiple calibration point pairs, determining the Jacobian matrix corresponding to the target calibration point pair; and according to the target calibration point pair and the predicted value of the distortion coefficient of the current round, obtaining, through a residual model in the iteration matrix model, a current residual matrix corresponding to the target calibration point pair; fusing the transpose of the Jacobian matrix corresponding to the target calibration point pair and the residual matrix corresponding to the target calibration point pair, to obtain a fused iteration matrix corresponding to the target calibration point pair; and superimposing fused iteration matrices respectively corresponding to the multiple calibration point pairs, to obtain the iteration matrix of the current round.

Specifically, the iteration matrix model may include a Jacobian matrix model and a residual model. When the iteration matrix of the current round needs to be determined, the computer device may input each coordinate pair of calibration points and the predicted value of the distortion coefficient of the current round into the Jacobian matrix model in the iteration matrix model, to obtain a Jacobian matrix corresponding to each coordinate pair of the calibration points. The computer device may also reuse the current Jacobian matrix corresponding to the current calibration point pair and generated when calculating the Hessian matrix.

Further, for each of the multiple calibration point pairs, the target calibration point pair may be referred to as the current calibration point pair, and the computer device may input a coordinate pair corresponding to the current calibration point pair and the predicted value of the distortion coefficient of the current round into the residual model in the iteration matrix model, to obtain the residual matrix corresponding to the current calibration point pair outputted by the residual model. The computer device may determine the transpose of the Jacobian matrix corresponding to the current calibration point pair, and multiply the transpose of the Jacobian matrix corresponding to the current calibration point pair with the residual matrix corresponding to the current calibration point pair, to obtain a fused iteration matrix corresponding to the current calibration point pair. When obtaining the fused iteration matrices corresponding to the calibration point pairs, the computer device may superpose the fused iteration matrices corresponding to the calibration point pairs, to obtain the iteration matrix of the current round.

In an aspect, the computer device may set an initial value of the iteration matrix and traverse calibration point pairs. For the first traversed calibration point pair, the computer device may determine the Jacobian matrix and the residual matrix of the first traversed calibration point pair, and fuse the Jacobian matrix and the residual matrix of the first traversed calibration point pair, to obtain the fused iteration matrix of the first traversed calibration point pair. The computer device may superimpose the initial value of the fused iteration matrix and the fused Jacobian matrix to obtain a superimposed iteration matrix of the first traversed calibration point pair. The computer device may continue to determine a fused iteration matrix of a next traversed calibration point pair, and superimpose the fused iteration matrix of the next traversed calibration point pair and the superimposed iteration matrix of the first traversed calibration point pair, to obtain a superimposed iteration matrix of the next traversed calibration point pair. Iteration may be performed in this way until the last calibration point pair is traversed, and a superimposed iteration matrix of the last traversed calibration point pair may be used as the iteration matrix of the current round.

In an aspect, in the process of calculating the residual matrix corresponding to the i^{th} coordinate pair, assuming that the i^{th} coordinate pairis [(xᵤᵢ, yᵤᵢ), (x_{di}, y_{di})], the computer device may determine an undistorted distance rᵤᵢ corresponding to the first calibration point coordinates (xᵤᵢ, yᵤᵢ), determine a distorted distance rai corresponding to the second calibration point coordinates (x_{di}, y_{di}), and input (xᵤᵢ, yᵤᵢ), rᵤᵢ, (x_{di}, y_{di}), and r_{di} and the predicted value (c₁ⱼ, c₂ⱼ) of the distortion coefficient of the current round into the residual model

$$R ( {c}_{1} , {c}_{2} ) = [ \begin{matrix}F ( {c}_{1} , {c}_{2} ) \\ G ( {c}_{1} , {c}_{2} )\end{matrix} ] ,$$

to obtain the residual matrix

$$[ \begin{matrix}{x}_{di} * ( 1 + {c}_{1 j} * {r}_{di}^{3} + {c}_{2 j} * {r}_{di}^{5} ) - {x}_{ui} \\ {y}_{di} * ( 1 + {c}_{1 j} * {r}_{di}^{3} + {c}_{2 j} * {r}_{di}^{5} ) - {y}_{ui}\end{matrix} ]$$

of the i^{th} coordinate pair [(xᵤᵢ, yᵤᵢ), (x_{di}, y_{di})] of calibration points. The residual matrix corresponding to the i^{th} coordinate pair may be also the residual matrix corresponding to the i^{th} calibration point pair.

In the above aspect, by determining the fused iteration matrices of all the calibration point pairs, the iteration matrix of the current round can be quickly obtained based on the fused iteration matrices of all the calibration point pairs.

In an aspect, the Hessian matrix model may be generated based on the Jacobian matrix model, and the Jacobian matrix model may represent a partial derivative of the residual model in a direction of the distortion coefficient; the iteration matrix may be generated based on the Jacobian matrix model and the residual model; and the residual model may represent residual between the change between the coordinate before distortion and the coordinate after distortion determined based on the predicted value of the distortion coefficient and the change between the coordinate before distortion and the coordinate after distortion determined based on the actual value of the distortion coefficient.

Specifically, in the process of numerical fitting, the purpose of numerical fitting may be that residual between the predicted value of the distortion coefficient obtained through fitting and the actual value of the distortion coefficient is as close to 0 as possible. Based on this purpose, the residual model representing a difference between the change between the coordinate before distortion and the coordinate after distortion determined based on the predicted value of the distortion coefficient and the change between the coordinate before distortion and the coordinate after distortion determined based on the actual value of the distortion coefficient may be generated. In the process of numerical fitting, when the residual outputted by the residual matrix is close to zero, it may be considered that the predicted value of the distortion coefficient obtained through fitting at this time is approximate to the actual value of the distortion coefficient, and the fitting purpose is achieved. Therefore, the purpose of numerical fitting in this application may be equivalent to achieving a minimum value of least squares optimization for the residual. In the process of solving the minimum value of least squares optimization for the residual, the predicted value increment of the distortion coefficient in each iteration needs to be determined based on the Hessian matrix and the Jacobian matrix generated based on the residual model, so that final convergence determining of the predicted value increment of the distortion coefficient may be completed based on the predicted value increment of the distortion coefficient. When it is determined that the predicted value increment of the distortion coefficient converges, it may be determined that the residual outputted by the residual matrix is close to zero. In this case, the predicted value of the distortion coefficient obtained through iteration may be the target value.

In an aspect, the method further may include: obtaining the distortion relationship based on both the value of the distortion coefficient and the to-be-fitted distortion relationship; obtaining a to-be-displayed image, and performing anti-distortion processing on pixels in the to-be-displayed image according to the distortion relationship, to determine distortion correction positions respectively corresponding to the pixels; respectively moving the pixels in the to-be-displayed image to corresponding distortion correction positions, to obtain an anti-distortion image; and triggering the extended reality device to display the anti-distortion image.

Specifically, when the distortion coefficient of the extended reality model may be calibrated, that is, when the distortion relationship determined based on the distortion coefficient value is obtained, the computer device may obtain the to-be-displayed image, and perform anti-distortion processing on the to-be-displayed image according to the distortion relationship to obtain an anti-distortion image. The computer device may input the anti-distortion image into the extended reality device and triggers the extended reality device to display the anti-distortion image, so that human eyes can view a normal undistorted image through the extended reality device. The computer device may also trigger the extended reality device to perform anti-distortion processing on the to-be-displayed image according to the calibrated distortion relationship to obtain an anti-distortion image.

In an aspect, the distortion relationship may be specifically a function. For corresponding pixel coordinates of each pixel in the to-be-displayed image, the computer device may substitute the pixel coordinates of the current pixel into an inverse function of the distortion relationship to obtain a distortion correction position of the current pixel outputted by the inverse function. The computer device may combine corresponding distortion correction positions of pixels to obtain an anti-distortion image.

In an aspect, referring to FIG. 7, when the display of the extended reality device displays an anti-distortion image, light emitted when the display displays the anti-distortion image passes through the optical lens of the extended reality device, and appears as a normally displayed undistorted image from human eyes. FIG. 7 is a schematic diagram in which an extended reality device displays an image.

In the above aspect, by calibrating the distortion coefficient, the target distortion relationship may be determined based on the calibrated distortion coefficient, and a normally displayed undistorted image may be outputted based on the target distortion relationship. This greatly improves user experience.

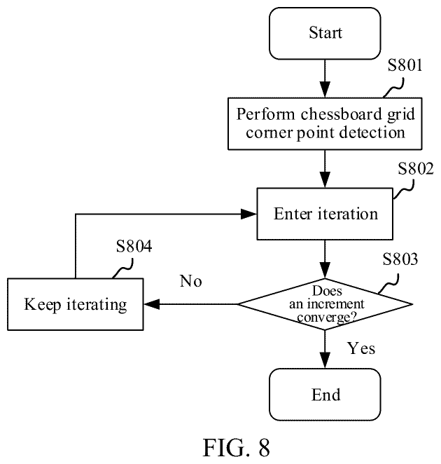

In an aspect, referring to FIG. 8, at step S801, a computer device may perform corner point detection on chessboard grid images acquired before and after distortion, to obtain multiple calibration point pairs. At step S802, the computer device may obtain a distortion coefficient value increment model and enters iteration, and obtain a predicted value increment of a distortion coefficient based on the distortion coefficient value increment model and the multiple calibration point pairs. At step S803, the computer device may determine whether the predicted value increment of the distortion coefficient converges. If yes, the iteration may be ended. If the predicted value increment of the distortion coefficient converges, at step S804, the computer device may continue the iteration until the predicted value increment of the distortion coefficient converges, and use a predicted value of the distortion coefficient at the time of convergence as a target value of the distortion coefficient. FIG. 8 is a schematic diagram of an overall flow of distortion coefficient calibration.

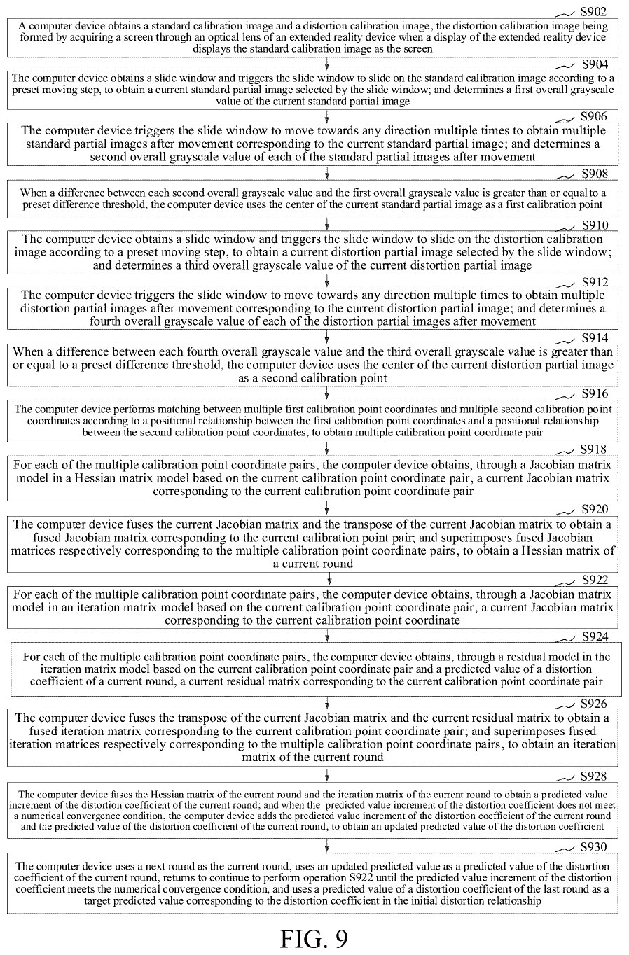

In a specific aspect, referring to FIG. 9, the distortion coefficient calibration method for an extended reality device may include:

At step S902, a computer device may obtain a standard calibration image and a distortion calibration image; the distortion calibration image being formed by acquiring a screen through an optical lens of an extended reality device when a display of the extended reality device displays the standard calibration image as the screen.

At step S904, the computer device may obtain a slide window and triggers the slide window to slide on the standard calibration image according to a preset moving step size, to obtain a current standard partial image selected by the slide window; and determines a first overall grayscale value of the current standard partial image.

At step S906, the computer device may trigger the slide window to move towards any direction multiple times to obtain multiple standard partial images after movement corresponding to the current standard partial image; and determines a second overall grayscale value of each of the standard partial images after movement.

At step S908, when a difference between each second overall grayscale value and the first overall grayscale value is greater than or equal to a preset difference threshold, the computer device may use the center of the current standard partial image as a first calibration point.

At step S910, the computer device may obtain a slide window and triggers the slide window to slide on the distortion calibration image according to a preset moving step size, obtain a current distortion partial image selected by the slide window; and determine a third overall grayscale value of the current distortion partial image.

At step S912, the computer device may trigger the slide window to move towards any direction multiple times to obtain multiple distortion partial images after movement corresponding to the current distortion partial image; and determines a fourth overall grayscale value of each of the distortion partial images after movement.

At step S914, when a difference between each fourth overall grayscale value and the third overall grayscale value is greater than or equal to a preset difference threshold, the computer device may use the center of the current distortion partial image as a second calibration point.

At step S916, the computer device may perform matching between multiple first calibration point coordinates and multiple second calibration point coordinates according to a positional relationship between the first calibration point coordinates and a positional relationship between the second calibration point coordinates, to obtain multiple calibration point pairs.

At step S918, for each of the multiple calibration point pairs, the computer device may obtain, through a Jacobian matrix model in a Hessian matrix model based on the current calibration point pair, a current Jacobian matrix corresponding to the current calibration point pair.

At step S920, the computer device may fuse the current Jacobian matrix and the transpose of the current Jacobian matrix to obtain a fused Jacobian matrix corresponding to the current calibration point pair; and superimpose fused Jacobian matrices respectively corresponding to the multiple calibration point pairs, to obtain a Hessian matrix of a current round.

At step S922, for each of the multiple calibration point pairs, the computer device may obtain, through a Jacobian matrix model in an iteration matrix model based on the current calibration point pair, a current Jacobian matrix corresponding to the current calibration point pair.

At step S924, for each of the multiple calibration point pairs, the computer device may obtain, through a residual model in the iteration matrix model based on the current calibration point pair and a predicted value of a distortion coefficient of a current round, a current residual matrix corresponding to the current calibration point pair.

At step S926, the computer device may fuse the transpose of the current Jacobian matrix and the current residual matrix to obtain a fused iteration matrix corresponding to the current calibration point pair; and superimpose fused iteration matrices respectively corresponding to the multiple calibration point pairs, to obtain an iteration matrix of the current round.

At step S928, the computer device may fuse the Hessian matrix of the current round and the iteration matrix of the current round to obtain a predicted value increment of the distortion coefficient of the current round; and when the predicted value increment of the distortion coefficient does not meet a numerical convergence condition, the computer device may add the predicted value increment of the distortion coefficient of the current round and the predicted value of the distortion coefficient of the current round, to obtain an updated predicted value of the distortion coefficient.

At step S930, the computer device may use a next round as the current round, use an updated predicted value as a predicted value of the distortion coefficient of the current round, return to continue to perform operation S922 until the predicted value increment of the distortion coefficient meets the numerical convergence condition, and use a predicted value of a distortion coefficient of the last round as a target predicted value corresponding to the distortion coefficient in the initial distortion relationship.

Although the operations are displayed sequentially according to the instructions of the arrows in the flowcharts, these operations are not necessarily performed sequentially according to the sequence instructed by the arrows. Unless otherwise explicitly specified in this application, execution of the operations may be not strictly limited, and the operations may be performed in other sequences. Moreover, at least some of the operations in flowcharts may include multiple sub-operations or multiple stages. The operations or stages are not necessarily performed at the same moment but may be performed at different moments. Execution of the operations or stages may be not necessarily sequentially performed, but may be performed alternately with other operations or at least some operations or stages of other operations.

This application further provides an application scenario that applies the above distortion coefficient calibration method for an extended reality device. Specifically, the application of the distortion coefficient calibration method for an extended reality device in this application scenario may be as follows:

When a distortion coefficient of an XR device needs to be calibrated, a to-be-fitted distortion relationship first may need to be obtained. A classic Brown model may be used as an example. This model may represent a distorted distance r_{d} based on a coefficient cₙ of an undistorted distance rᵤ, which is specifically as follows:

$$\{ \begin{matrix}{r}_{d} = f ( {r}_{u} ) = {r}_{u} + {c}_{1} {r}_{u}^{3} + {c}_{2} {r}_{u}^{5} \\ {r}^{2} = {x}^{2} + {y}^{2}\end{matrix}$$

It can be seen that there are two unknown coefficients c₁ and c₂ above, and the purpose of calibration in this system may be to obtain specific values of the two coefficients through fitting. Specifically, during calibration, the system may first input a standard chessboard grid image, then directly input the image into an optical display, obtain a distorted chessboard grid image (with a white background) through a high-definition camera, and finally obtain chessboard grid corner point coordinate positions (also referred to as multiple calibration point pairs) before and after distortion through corner point detection (including but not limited to opencv corner point detection). At this point, preparation work required for the calibration process has been completed. Then, corresponding chessboard grid corner point coordinates (also referred to as multiple calibration point pairs) before and after distortion may be used as an input of numerical fitting, to obtain a coefficient in the distortion relationship through fitting to obtain a complete forward distortion relationship. A numerical fitting process may be specifically as follows:

During calibration, the purpose of numerical fitting may be that residual of a coordinate change caused by fitted distortion coefficient (c₁, c₂) and actual distortion coefficients (c₁′, c₂′) may be as close to zero as possible herein, the Brown model may be used as an example). Therefore, a caused residual relationship may be as follows:

$$F ( {c}_{1} , {c}_{2} ) = {\sum }_{i = 1}^{N} [ {x}_{di} ( 1 + {c}_{1} {r}_{di}^{3} + {c}_{2} {r}_{di}^{5} ) - {x}_{ui} ] \\ G ( {c}_{1} , {c}_{2} ) = {\sum }_{i = 1}^{N} [ {y}_{di} ( 1 + {c}_{1} {r}_{di}^{3} + {c}_{2} {r}_{di}^{5} ) - {y}_{ui} ]$$

To achieve a minimum value (that is, close to 0) of the least squares optimization for the residual, partial derivatives in the directions c₁ and c₂ need to be solved to form a Jacobian matrix, which may be specifically as follows:

$$J ( {c}_{1} , {c}_{2} ) = [ \begin{matrix}\frac{\partial F ( {c}_{1} , {c}_{2} )}{\partial {c}_{1}} & \frac{\partial F ( {c}_{1} , {c}_{2} )}{\partial {c}_{2}} \\ \frac{\partial G ( {c}_{1} , {c}_{2} )}{\partial {c}_{1}} & \frac{\partial G ( {c}_{1} , {c}_{2} )}{\partial {c}_{2}}\end{matrix} ]$$

Then, through Taylor expansion, a Gauss-Newton condition, and the first-order derivative being zero, changes in two coordinate dimensions in each iteration are obtained as follows:

$$[ \begin{matrix}Δ {c}_{1} \\ Δ {c}_{2}\end{matrix} ] = {( {J ( {c}_{1} , {c}_{2} )}^{T} J ( {c}_{1} , {c}_{2} ) )}^{- 1} ( - {J ( {c}_{1} , {c}_{2} )}^{T} r ( {c}_{1} , {c}_{2} ) )$$

a relationship r(c₁, c₂) may be as follows:

$$R ( {c}_{1} , {c}_{2} ) = [ \begin{matrix}F ( {c}_{1} , {c}_{2} ) \\ G ( {c}_{1} , {c}_{2} )\end{matrix} ]$$

At this point, increments Δc₁ and Δc₂ in dimensions c₁ and c₂ in each iteration may be obtained, then Δc₁ and Δc₂ are calculated through continuous iteration, and it may be determined whether values thereof converge to a very small range (which may be set to 1e⁻⁸ in this system). If yes, coefficients relative to all chessboard grid corner points before and after distortion may be obtained. That is, the calibration function may be completed. The obtained distortion coefficients may be directly used in subsequent distortion correction processing. Only after a distortion image may be accurately corrected, related subsequent processing (including but not limited to, image display and image quality enhancement) may be smooth. For specific meaning of each parameter in the above formula, refer to the above aspect.

Aspects described herein further provide another application scenario that applies the above distortion coefficient calibration method for an extended reality device. Specifically, the application of the distortion coefficient calibration method for an extended reality device in this application scenario may be as follows:

A user may enter a virtual reality world through an extended reality device. For example, a user may play games for entertainment through an extended reality device (an XR device) to enter an interactive virtual reality game scene. Before the user plays games for entertainment through the XR device, a distortion coefficient may be calibrated in advance through the distortion coefficient calibration method proposed in this application, so that the XR device may adjust and display the to-be-displayed virtual reality game scene according to the calibrated distortion coefficient. In this way, the virtual reality game scene viewed by the user may be an undistorted scene. By displaying the undistorted virtual reality game scene, the user can experience an immersive game.

The above application scenarios are only exemplary illustrations. The application of the distortion coefficient calibration method for an extended reality device is not limited to the above scenarios. For example, before a user performs entertainment and navigation through an extended reality device, a distortion coefficient may also be calibrated in advance through the distortion coefficient calibration method. For example, before a user watches a VR movie (also referred to as a virtual reality movie) through an extended reality device, a distortion coefficient may be calibrated in advance, so that the extended reality device may display undistorted movie images to the user based on the calibrated distortion coefficient. For example, before a user performs navigation through an extended reality device, a distortion coefficient may also be calibrated in advance, so that the extended reality device may display undistorted road images with virtual scenes and real scenes to the user based on the calibrated distortion coefficient.

Based on the same inventive concept, aspects described herein further provide a distortion coefficient calibration apparatus for an extended reality device that may be configured to implement the distortion coefficient calibration method for an extended reality device. The implementation solution to the problem provided by the apparatus may be similar to the implementation solution described in the above method. Therefore, for specific definitions in one or more aspects of the distortion coefficient calibration apparatus for an extended reality device provided below, refer to the above definitions in the distortion coefficient calibration method for an extended reality device. Details are not repeated herein.

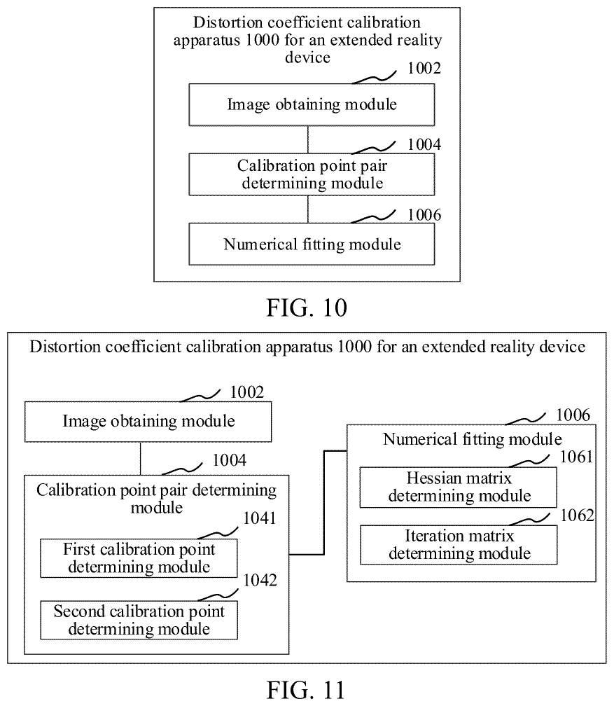

In an aspect, as shown in FIG. 10, a distortion coefficient calibration apparatus for an extended reality device may be provided, including: an image obtaining module 1002, a calibration point pair determining module 1004, and a numerical fitting module 1006.

The image obtaining module 1002 may be configured to obtain a standard calibration image and a distortion calibration image, the distortion calibration image being formed by acquiring a screen through an optical lens of an extended reality device when a display of the extended reality device displays the standard calibration image as the screen.

The calibration point pair determining module 1004 may be configured to perform calibration point detection based on the standard calibration image and the distortion calibration image to obtain multiple calibration point pairs, each of the calibration point pairs including a first calibration point belonging to the standard calibration image and a second calibration point belonging to the distortion calibration image, and the second calibration point being a corresponding calibration point obtained by acquiring the first calibration point through the optical lens of the extended reality device.

The numerical fitting module 1006 may be configured to obtain a to-be-fitted distortion relationship, and perform numerical fitting on the to-be-fitted distortion relationship according to the multiple calibration point pairs, to determine a value of the distortion coefficient in the to-be-fitted distortion relationship to obtain a distortion relationship, the distortion relationship being configured for representing a conversion relationship between calibration points in the standard calibration image and the distortion calibration image.

In an aspect, the distortion calibration image may be acquired by an image acquisition device; and in a process in which the image acquisition device acquires the distortion calibration image, the optical lens of the extended reality device may be located between the image acquisition device and the display of the extended reality device, and the optical center of the optical lens may be aligned with the center of the display.

In an aspect, referring to FIG. 11, the calibration point pair determining module 1004 may be further configured to perform calibration point detection on the standard calibration image to obtain multiple first calibration points, and determine coordinates of each of the first calibration points in the standard calibration image, to obtain first calibration point coordinates respectively corresponding to the multiple first calibration points; perform calibration point detection on the distortion calibration image to obtain multiple second calibration points, and determine coordinates of each of the second calibration points in the distortion calibration image, to obtain second calibration point coordinates respectively corresponding to the multiple second calibration points; determine a positional relationship between the first calibration points according to the first calibration point coordinates respectively corresponding to the multiple first calibration points; determine a positional relationship between the second calibration points according to the second calibration point coordinates respectively corresponding to the multiple second calibration points; and perform matching between the multiple first calibration points and the multiple second calibration points according to the positional relationship between the first calibration points and the positional relationship between the second calibration points, to obtain the multiple calibration point pairs.

In an aspect, the calibration point pair determining module 1004 further includes a first calibration point determining module 1041, configured to obtain a slide window and trigger the slide window to slide on the standard calibration image according to a preset moving step size, to obtain a standard partial image selected by the slide window; determine a first overall grayscale value of the standard partial image based on grayscale values of pixels in the standard partial image; trigger the slide window to move towards any direction multiple times to obtain multiple standard partial images after movement corresponding to the standard partial image; determine a second overall grayscale value of each of the standard partial images after movement based on grayscale values of pixels in the standard partial image after movement; and extract the first calibration point from the standard partial image according to a difference between each second overall grayscale value and the first overall grayscale value.

In an aspect, the first calibration point determining module 1041 may be further configured to perform subtraction on each second overall grayscale value and the first overall grayscale value to obtain a grayscale difference corresponding to each second overall grayscale value; obtain a preset difference threshold, and select absolute values greater than or equal to the preset difference threshold from absolute values of grayscale differences; determine a number of the selected absolute values; and obtain a preset number threshold, and when the number may be greater than or equal to the preset number threshold, use the center of the standard partial image as the first calibration point.

In an aspect, the calibration point pair determining module 1004 may further include a second calibration point determining module 1042, configured to obtain a slide window and trigger the slide window to slide on the distortion calibration image according to a preset moving step size, to obtain a distortion partial image selected by the slide window; determine a third overall grayscale value of the distortion partial image based on grayscale values of pixels in the distortion partial image; trigger the slide window to move towards any direction multiple times to obtain multiple distortion partial images after movement corresponding to the distortion partial image; determine a fourth overall grayscale value of each of the distortion partial images after movement based on grayscale values of pixels in the distortion partial image after movement; and extract the second calibration point from the distortion partial image according to a difference between each fourth overall grayscale value and the third overall grayscale value.

In an aspect, the numerical fitting module 1006 may be further configured to obtain a preset distortion coefficient value increment model; where the distortion coefficient value increment model may be a model for determining a change amount of a predicted value of the distortion coefficient in two consecutive iterations; determine a predicted value of the distortion coefficient of a current round; obtain a predicted value increment of the distortion coefficient of the current round through the distortion coefficient value increment model according to the multiple calibration point pairs and the predicted value of the distortion coefficient of the current round; obtain a numerical convergence condition, and when the predicted value increment of the distortion coefficient does not meet the numerical convergence condition, add the predicted value increment of the distortion coefficient of the current round and the predicted value of the distortion coefficient of the current round, to obtain an updated predicted value of the distortion coefficient; use a next round as the current round, use the updated predicted value as a predicted value of the distortion coefficient of the current round, and return to continue to perform the operation of obtaining a predicted value increment of the distortion coefficient of the current round through the distortion coefficient value increment model according to the multiple calibration point pairs and the predicted value of the distortion coefficient of the current round, until the predicted value increment of the distortion coefficient meets the numerical convergence condition; and use a predicted value of the distortion coefficient of the last round as the value corresponding to the distortion coefficient in the to-be-fitted distortion relationship.

In an aspect, the distortion coefficient value increment model may be determined based on a residual model; the residual model may be determined based on the to-be-fitted distortion relationship; the residual model represents residual between a first coordinate change and a second coordinate change; the first coordinate change may be a change between a coordinate before distortion and a coordinate after distortion determined based on the predicted value of the distortion coefficient; and the second coordinate change may be a change between a coordinate before distortion and a coordinate after distortion determined based on an actual value of the distortion coefficient.

In an aspect, the numerical fitting module 1006 may be further configured to obtain a Hessian matrix of the current round through a Hessian matrix model in the distortion coefficient value increment model according to the multiple calibration point pairs; obtain an iteration matrix of the current round through an iteration matrix model in the distortion coefficient value increment model according to the multiple calibration point pairs and the predicted value of the distortion coefficient of the current round; and fuse the Hessian matrix of the current round and the iteration matrix of the current round to obtain the predicted value increment of the distortion coefficient of the current round.

In an aspect, the numerical fitting module 1006 may further include a Hessian matrix determining module 1061, and be configured to: for each of the multiple calibration point pairs, determine coordinates of the first calibration point belonging to the standard calibration image in the target calibration point pair, and determine coordinates of the second calibration point belonging to the distortion calibration image in the target calibration point pair; according to the coordinates of the first calibration point belonging to the standard calibration image and the coordinates of the second calibration point belonging to the distortion calibration image in the target calibration point pair, determine a coordinate pair corresponding to the target calibration point pair; obtain, through a Jacobian matrix model in the Hessian matrix model according to the coordinate pair, a Jacobian matrix corresponding to the target calibration point pair; fuse the Jacobian matrix and the transpose of the Jacobian matrix to obtain a fused Jacobian matrix corresponding to the target calibration point pair; and superimpose fused Jacobian matrices respectively corresponding to the multiple calibration point pairs, to obtain the Hessian matrix of the current round.

In an aspect, the numerical fitting module 1006 may further include an iteration matrix determining module 1062, and may be configured to: according to the target calibration point pair and the predicted value of the distortion coefficient of the current round, obtain, through a residual model in the iteration matrix model, a residual matrix corresponding to the target calibration point pair; fuse the transpose of the Jacobian matrix corresponding to the target calibration point pair and the residual matrix corresponding to the target calibration point pair, to obtain a fused iteration matrix corresponding to the target calibration point pair; and superimpose fused iteration matrices respectively corresponding to the multiple calibration point pairs, to obtain the iteration matrix of the current round.

In an aspect, the Hessian matrix model may be generated based on the Jacobian matrix model, and the Jacobian matrix model may represent a partial derivative of the residual model in a direction of the distortion coefficient; the iteration matrix may be generated based on the Jacobian matrix model and the residual model; and the residual model may represent residual between the change between the coordinate before distortion and the coordinate after distortion determined based on the predicted value of the distortion coefficient and the change between the coordinate before distortion and the coordinate after distortion determined based on the actual value of the distortion coefficient.

In an aspect, the distortion coefficient calibration apparatus 1000 for an extended reality device may further include an anti-distortion module, and may be configured to obtain the distortion relationship based on both the value of the distortion coefficient and the to-be-fitted distortion relationship; obtain a to-be-displayed image, and perform anti-distortion processing on pixels in the to-be-displayed image according to the distortion relationship, to determine distortion correction positions respectively corresponding to the pixels in the to-be-displayed image; respectively move the pixels to corresponding distortion correction positions, to obtain an anti-distortion image; and trigger the extended reality device to display the anti-distortion image.

Each module in the distortion coefficient calibration apparatus for an extended reality device may be implemented entirely or partially through software, hardware, or a combination thereof. The above-mentioned modules may be embedded in the processor in the computer device in the form of hardware or independent of the processor in the computer device, and may also be stored in the memory of the computer device in the form of software, so that the processor may invoke and execute the corresponding operations of the above-mentioned modules.

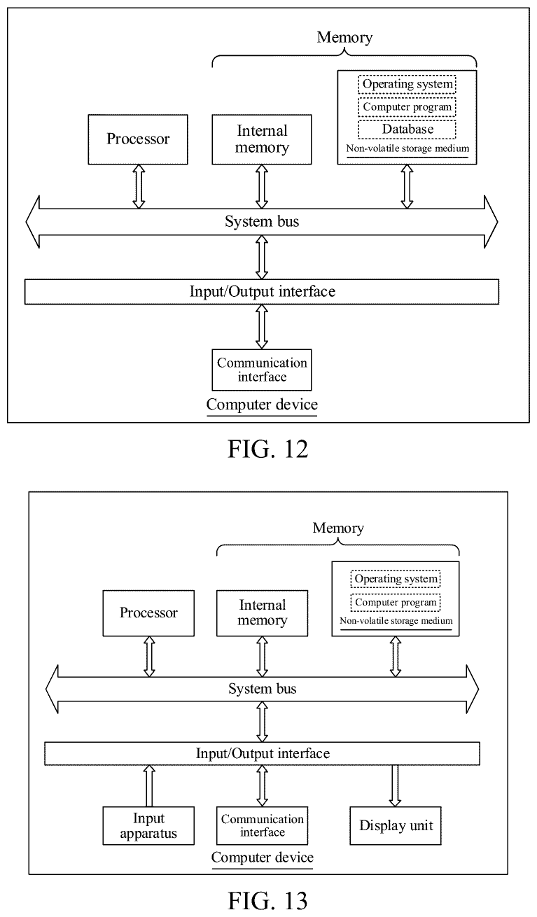

In an aspect, a computer device may be provided and may be a server. An internal structure thereof may be shown in FIG. 12. The computer device may include a processor, a memory, an input/output interface (I/O for short), and a communication interface. The processor, the memory, and the input/output interface may be connected through a system bus, and the communication interface may be connected to the system bus through the input/output interface. The processor of the computer device may be configured to provide computation and control ability. The memory of the computer device may include a non-volatile storage medium and an inner memory. The non-volatile storage medium may store an operating system, computer programs, and databases. The inner memory may provide an operating environment for the operating system and the computer programs in the non-volatile storage medium. The database of the computer device may be configured to store distortion coefficient calibration data of an extended reality device. The input/output interface of the computer device may be configured to exchange information between the processor and external devices. The communication interface of the computer device may be configured to communicate with an external terminal by using a network connection. The computer program may be executed by the processor to implement a distortion coefficient calibration method for an extended reality device.

In an aspect, a computer device may be provided and may be a terminal. An internal structure thereof may be shown in FIG. 13. The computer device may include a processor, a memory, an input/output interface, a communication interface, a display unit, and an input apparatus. The processor, the memory, and the input/output interface may be connected through a system bus, and the communication interface, the display unit, and the input apparatus are connected to the system bus through the input/output interface. The processor of the computer device may be configured to provide computation and control ability. The memory of the computer device may include a non-volatile storage medium and an inner memory. The non-volatile storage medium may store an operating system and computer programs. The inner memory may provide an operating environment for the operating system and the computer programs in the non-volatile storage medium. The input/output interface of the computer device may be configured to exchange information between the processor and external devices. The communication interface of the computer device may be configured to communicate with external terminals in a wired or wireless mode. The wireless mode may be implemented through WIFI, mobile cellular networks, near field communication (NFC) or other technologies. The computer program may be executed by the processor to implement a distortion coefficient calibration method for an extended reality device. The display unit of the computer device may be configured to form visual images, and may be a display screen, a projection apparatus, or an extended reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that, the structure shown in FIG. 12 and FIG. 13 may be merely a block diagram of a partial structure related to a solution in this application, and does not constitute a limitation to the computer device to which the solution in this application may be applied. Specifically, the computer device may include more or fewer components than those shown in the figure, or have some components combined, or have a different component deployment.

In an aspect, a computer device may be further provided, including: a memory and a processor, the memory stores computer programs, and the computer program may be executed by the processor to perform the operations of the foregoing method aspects.

In an aspect, a computer-readable storage medium may be provided, having computer programs stored therein, and the computer program may be executed by a processor to perform the operations of the foregoing method aspects.

In an aspect, a computer program product or a computer program may be provided, including computer instructions stored in a computer-readable storage medium. A processor of a computer device reads the computer instructions from the computer-readable storage medium, and the processor executes the computer instructions, so that the computer device performs the operations of the foregoing method aspects.

The user information (including but not limited to user equipment information, user personal information, or the like) and data (including but not limited to data used for analysis, stored data, displayed data, or the like) involved in this application are information and data that are authorized by the user or that have been fully authorized by all parties, and the collection, use and processing of relevant data need to comply with relevant laws, regulations and standards of relevant countries and regions.

A person of ordinary skill in the art may understand that all or some of procedures of the method in the foregoing aspects may be implemented by a computer program instructing relevant hardware. The computer program may be stored in a non-volatile computer-readable storage medium. When the computer program may be executed, the procedures of the foregoing method aspects may be implemented. References to the memory, the database, or other medium used in the aspects provided in this application may all include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM) or an external cache. As an illustration and not a limitation, the RAM may be in various forms, such as a static random access memory (SRAM) or a dynamic random access memory (DRAM). The database involved in the various aspects provided in this application may include at least one of a relational database and a non-relational database. The non-relational database may include a blockchain-based distributed database or the like, but may be not limited thereto. The processors involved in the various aspects provided by this application may be general-purpose processors, central processing units, graphics processors, digital signal processors, programmable logic devices, data processing logic devices based on quantum computing, and are not limited thereto.

Technical features of the foregoing aspects may be randomly combined. To make description concise, not all possible combinations of the technical features in the foregoing aspects are described. However, the combinations of these technical features shall be considered as falling within the scope recorded by this specification provided that no conflict exists.

The foregoing aspects show only several implementations of this application and are described in detail, which, however, are not to be construed as a limitation to the patent scope of this application. For a person of ordinary skill in the art, several transformations and improvements may be made without departing from the idea of this application. These transformations and improvements belong to the protection scope of this application. Therefore, the protection scope of this application shall be subject to the appended claims.

What is claimed is:

1. A method, comprising:
receiving:
a standard calibration image; and
a distortion calibration image of a display of an extended reality device;
performing calibration point detection on the standard calibration image and the distortion calibration image to obtain a plurality of calibration point pairs, wherein each of the plurality of calibration point pairs comprises a first calibration point indicating a location of a portion of the standard calibration image and a second calibration point indicates a location, of the same portion of the standard calibration image, in the distortion calibration image;
obtaining, for each of the plurality of calibration point pairs, a to-be-fitted distortion relationship associated with the first calibration point and the second calibration point and comprising a to-be-fitted distortion coefficient;
performing, for each of one or more of the plurality of calibration point pairs, numerical fitting on the to-be-fitted distortion relationship to determine a distortion coefficient, in the to-be-fitted distortion relationship, associated with the first calibration point and the second calibration point; and
causing, based on the determined distortion coefficients of the one or more of the plurality of calibration point pairs, the extended reality device to adjust display of another image.

2. The method of claim 1, wherein the performing calibration point detection on the standard calibration image and the distortion calibration image comprises:
performing calibration point detection on the standard calibration image to obtain a plurality of first calibration points;
performing calibration point detection on the distortion calibration image to obtain a plurality of second calibration points;
determining a plurality of first positional relationships between the plurality of first calibration points;
determining a plurality of second positional relationships between the plurality of second calibration points; and
matching, based on the plurality of first positional relationships and the plurality of second positional relationships and to form the plurality of calibration point pairs, each one of the plurality of first calibration points with a different one of the plurality of second calibration points.

3. The method of claim 1, wherein the performing calibration point detection on the standard calibration image further comprises:
generating a first standard partial image by triggering a slide window to slide on the standard calibration image in a first direction;
determining, based on grayscale values of pixels in the first standard partial image, a first overall grayscale value of the first standard partial image;
generating a second standard partial image by triggering the slide window to slide on the standard calibration image in a second direction different than the first direction;
determining, based on grayscale values of pixels in the second standard partial image, a second overall grayscale value of the second standard partial images; and
extracting, based on a difference between the second overall grayscale value and the first overall grayscale value, the first calibration point of one of the plurality of calibration point pairs.

4. The method of claim 3, wherein the performing calibration point detection on the distortion calibration image comprises:
generating a first distortion partial image by triggering the slide window to slide on the distortion calibration image in a third direction;
determining, based on grayscale values of pixels in the first distortion partial image, a third overall grayscale value of the first distortion partial image;
generating a second distortion partial image by triggering the slide window to slide on the distortion calibration image in a fourth direction different than the third direction;
determining, based on grayscale values of pixels in the second distortion partial image, a fourth overall grayscale value of the second distortion partial image; and
extracting, based on a difference between the fourth overall grayscale value and the third overall grayscale value, the second calibration point of the one of the plurality of calibration point pairs.

5. The method of claim 1, wherein the performing numerical fitting on the to-be-fitted distortion relationship for each of one or more of the plurality of calibration point pairs comprises:
iteratively determining, via a distortion coefficient value increment model, a predicted value increment of the distortion coefficient until the a difference in the predicted value increment of the distortion coefficient in two consecutive iterations satisfy a numerical convergence condition; and
using the predicted value increment of the distortion coefficient as the distortion coefficient in the to-be-fitted distortion relationship.

6. The method of claim 5, wherein:
the distortion coefficient value increment model is determined based on a residual model;
the residual model is determined based on the to-be-fitted distortion relationship;
the residual model represents residual between a first coordinate change and a second coordinate change;
the first coordinate change is a change between a coordinate before distortion and a coordinate after distortion determined based on the predicted value increment of the distortion coefficient; and
the second coordinate change is a change between a coordinate before distortion and a coordinate after distortion determined based on an actual value of the distortion coefficient.

7. The method of claim 5, wherein the iteratively determining the predicted value increment of the distortion coefficient comprises:
determining, for the one or more of the plurality of calibration point pairs, a Hessian matrix of a first iteration in the distortion coefficient value increment model;
determining an iteration matrix of the next iteration based on the predicted value increment of the distortion coefficient of the first iteration; and
fusing the Hessian matrix of the first iteration and the iteration matrix of the next iteration to obtain the predicted value increment of the distortion coefficient of the first iteration.

8. The method of claim 7, wherein the determining the Hessian matrix of the first iteration comprises:
for each of the one or more of the plurality of calibration point pairs and based on a Hessian matrix model and a Jacobian matrix model:
determining first coordinates of the first calibration point and second coordinates of the second calibration point;
determining, based on the first coordinates and the second coordinates, a Jacobian matrix; and
fusing the Jacobian matrix and a transpose of the Jacobian matrix to obtain a fused Jacobian matrix; and
superimposing fused Jacobian matrices, of the one or more of the plurality of calibration point pairs, to obtain the Hessian matrix of the first iteration.

9. The method of claim 8, wherein the determining the Hessian matrix of the first iteration comprises:
for each of the one or more of the plurality of calibration point pairs and based on a residual model:
determining a residual matrix; and
fusing the transpose of the Jacobian matrix and the residual matrix to obtain a fused iteration matrix corresponding; and
superimposing fused iteration matrices, of the one or more of the plurality of calibration point pairs, to obtain an iteration matrix of the first iteration.

10. The method of claim 9, wherein the Hessian matrix model is generated based on the Jacobian matrix model, and the Jacobian matrix model represents a partial derivative of the residual model in a direction of the distortion coefficient.

11. The method of claim 1, wherein the adjusting the display of the another image comprises:
performing, based on the determined distortion coefficients of the one or more of the plurality of calibration point pairs, anti-distortion processing on a plurality of pixels in the another image in the another image to determine a distortion corrected position of each of the plurality of pixels; and
moving, in the another image, each of the plurality of pixels to the distortion correction position of the each of the plurality of pixels.

12. An extended reality device, comprising:
one or more processors; and
memory storing instructions that, when executed by the one or more processors, cause the extended reality device to:
receive:
a standard calibration image; and
a distortion calibration image of a display of the extended reality device;
perform calibration point detection on the standard calibration image and the distortion calibration image to obtain a plurality of calibration point pairs, wherein each of the plurality of calibration point pairs comprises a first calibration point indicating a location of a portion of the standard calibration image and a second calibration point indicates a location, of the same portion of the standard calibration image, in the distortion calibration image;
obtain, for each of the plurality of calibration point pairs, a to-be-fitted distortion relationship associated with the first calibration point and the second calibration point and comprising a to-be-fitted distortion coefficient;
perform, for each of one or more of the plurality of calibration point pairs, numerical fitting on the to-be-fitted distortion relationship to determine a distortion coefficient, in the to-be-fitted distortion relationship, associated with the first calibration point and the second calibration point; and
cause, based on the determined distortion coefficients of the one or more of the plurality of calibration point pairs, adjusting display of another image.

13. The extended reality device of claim 12, wherein the instructions, when executed by the one or more processors, further cause the extended reality device to perform calibration point detection on the standard calibration image and the distortion calibration image by:
performing calibration point detection on the standard calibration image to obtain a plurality of first calibration points;
performing calibration point detection on the distortion calibration image to obtain a plurality of second calibration points;
determining a plurality of first positional relationships between the plurality of first calibration points;
determining a plurality of second positional relationships between the plurality of second calibration points; and
matching, based on the plurality of first positional relationships and the plurality of second positional relationships and to form the plurality of calibration point pairs, each one of the plurality of first calibration points with a different one of the plurality of second calibration points.

14. The extended reality device of claim 12, wherein the instructions, when executed by the one or more processors, further cause the extended reality device to perform calibration point detection on the standard calibration image by:
generating a first standard partial image by triggering a slide window to slide on the standard calibration image in a first direction;
determining, based on grayscale values of pixels in the first standard partial image, a first overall grayscale value of the first standard partial image;
generating a second standard partial image by triggering the slide window to slide on the standard calibration image in a second direction different than the first direction;
determining, based on grayscale values of pixels in the second standard partial image, a second overall grayscale value of the second standard partial images; and
extracting, based on a difference between the second overall grayscale value and the first overall grayscale value, the first calibration point of one of the plurality of calibration point pairs.

15. The extended reality device of claim 12, wherein the instructions, when executed by the one or more processors, further cause the extended reality device to perform numerical fitting on the to-be-fitted distortion relationship for each of one or more of the plurality of calibration point pairs by:
iteratively determining, via a distortion coefficient value increment model, a predicted value increment of the distortion coefficient until the a difference in the predicted value increment of the distortion coefficient in two consecutive iterations satisfy a numerical convergence condition; and
using the predicted value increment of the distortion coefficient as the distortion coefficient in the to-be-fitted distortion relationship.

16. The extended reality device of claim 12, wherein the instructions, when executed by the one or more processors, further cause the extended reality device to adjust the display of the another image by:
performing, based on the determined distortion coefficients of the one or more of the plurality of calibration point pairs, anti-distortion processing on a plurality of pixels in the another image in the another image to determine a distortion corrected position of each of the plurality of pixels; and
moving, in the another image, each of the plurality of pixels to the distortion correction position of the each of the plurality of pixels.

17. A non-transitory computer-readable storage medium, storing computer readable instructions that, when executed by a processor, cause a data processing system to perform:
receiving:
a standard calibration image; and
a distortion calibration image of a display of an extended reality device;
performing calibration point detection on the standard calibration image and the distortion calibration image to obtain a plurality of calibration point pairs, wherein each of the plurality of calibration point pairs comprises a first calibration point indicating a location of a portion of the standard calibration image and a second calibration point indicates a location, of the same portion of the standard calibration image, in the distortion calibration image;
obtaining, for each of the plurality of calibration point pairs, a to-be-fitted distortion relationship associated with the first calibration point and the second calibration point and comprising a to-be-fitted distortion coefficient;
performing, for each of one or more of the plurality of calibration point pairs, numerical fitting on the to-be-fitted distortion relationship to determine a distortion coefficient, in the to-be-fitted distortion relationship, associated with the first calibration point and the second calibration point; and
causing, based on the determined distortion coefficients of the one or more of the plurality of calibration point pairs, the extended reality device to adjust display of another image.

18. The non-transitory computer-readable storage medium of claim 17, wherein the computer readable instructions that, when executed by the processor, further cause the data processing system to perform calibration point detection on the standard calibration image and the distortion calibration image by:
performing calibration point detection on the standard calibration image to obtain a plurality of first calibration points;
performing calibration point detection on the distortion calibration image to obtain a plurality of second calibration points;
determining a plurality of first positional relationships between the plurality of first calibration points;
determining a plurality of second positional relationships between the plurality of second calibration points; and
matching, based on the plurality of first positional relationships and the plurality of second positional relationships and to form the plurality of calibration point pairs, each one of the plurality of first calibration points with a different one of the plurality of second calibration points.

19. The non-transitory computer-readable storage medium of claim 17, wherein the computer readable instructions that, when executed by the processor, further cause the data processing system to perform numerical fitting on the to-be-fitted distortion relationship for each of one or more of the plurality of calibration point pairs by:
iteratively determining, via a distortion coefficient value increment model, a predicted value increment of the distortion coefficient until the a difference in the predicted value increment of the distortion coefficient in two consecutive iterations satisfy a numerical convergence condition; and
using the predicted value increment of the distortion coefficient as the distortion coefficient in the to-be-fitted distortion relationship.

20. The non-transitory computer-readable storage medium of claim 17, wherein the computer readable instructions that, when executed by the processor, further cause the data processing system to adjust the display of the another image by:
performing, based on the determined distortion coefficients of the one or more of the plurality of calibration point pairs, anti-distortion processing on a plurality of pixels in the another image in the another image to determine a distortion corrected position of each of the plurality of pixels; and
moving, in the another image, each of the plurality of pixels to the distortion correction position of the each of the plurality of pixels.
